(19) United States
(12) Patent Application Publication
(10) Pub. No.: US 2024/0308833 A1
(43) Pub. Date: Sep. 19, 2024

(54) Method and inspection apparatus for inspecting containers provided with closures, and method and closure apparatus for closing containers

(71) Applicant: KRONES AG, Neutraubling (DE)

(72) Inventors: Anton NIEDERMEIER, Offenstetten (DE); Thomas BOCK, Hemau (DE)

(21) Appl. No.: 18/606,725

(22) Filed: Mar. 15, 2024

(30) Foreign Application Priority Data
Mar. 15, 2023 (DE) 10 2023 106 512.2

(51) Int. Cl. B67B 3/26; B67B 3/20; G01M 3/38; G06T 1/00; G06T 7/00; G06T 7/11; G06T 7/60; G06T 7/73

(52) U.S. Cl. CPC B67B 3/26; B67B 3/204; G01M 3/38; G06T 1/0014; G06T 7/001; G06T 7/11; G06T 7/60; G06T 7/74; G06T 2207/10152; G06T 2207/20081; G06T 2207/30204

(57) ABSTRACT

Disclosed is a method for inspecting sealing between a closure arranged on a mouth region of a container by performing a screwing-on operation on a mouth region of the container while the container is transported along a transport path, and during transport illuminating the containers by a lighting device and recording at least one spatially resolved image of the container. An image evaluation device determines, on the basis of the relative position depicted in the at least one spatially resolved image, at least one closure rotation angle by which the closure was rotated in the course of the performed screwing—in operation, a characteristic closure rotation angle variable.

### BACKGROUND OF THE INVENTION

The present invention relates to a method and an inspection apparatus for inspecting containers provided with closures in order to check a sealing function between the closure and a container provided therewith.

Inspection apparatus, closure apparatuses and methods for closing containers and for inspecting containers provided with closures have long been known from the prior art.

From the prior art, disposable PET containers and their (screw) closures are known which have clear markings. The marking is in a fixed relationship with the thread orientation. If the closure is applied correctly, the two markings must be at a specific angle relative to one another (relative to the container axis) or in a different kind of relationship. Manufacturing and application tolerances are defined by the permissible tolerated spacing of the two markings. As long as the closure and container markings are within them, it is ensured that the sealing concept (closure-mouthpiece) works correctly.

Usually are marking(s) which has/have a fixed relationship to the phase position of the thread in the closure piece and are applied as visually inconspicuously as possible on the closure. For example, a web of the knurled region is somewhat shortened.

Usually are marking(s) on the container support ring or in the neck area below the ring which have a fixed relationship to the phase position of the thread on the mouthpiece.

The closures that were heretofore common usually had no logo or embossing on the cap, and if they had such features, it is not certain that they had a phase relationship to the thread in the mouthpiece.

From DE 10 2017 119 074 B4 a method for error analysis of a screw closure of a container made of PET is known in which a first marking on the closure cap and a second marking on the container are optically detected by a detection unit, wherein during the recording of the first image a lighting device is projected onto the container using fluorescent UV light to relatively brighten the PET of the container. By means of a processing apparatus, a relative angular distance of the markings in relation to the axis of rotation is determined from the images. The images are recorded from above, i.e., the optical axis of the cameras of the detection devices run in the direction of the longitudinal axis of the container for recording.

From WO 2014/023580, a system and a method for inspecting seals in closures attached to a container with a thread are known. Both the support ring of the container and the closure have a marking which is detected by the same camera.

WO 2019/025956 A1 discloses a method for detecting the rotational position of a closure in relation to a bottle onto which this closure is attached. For this purpose, a first marking is provided on the surface of the closure and a second marking is provided on the surface of the bottle. In this case, an image of the marking and, after removal of liquid droplets, a further image of the corresponding marking is initially recorded, which are each compared to one another.

The disadvantage of the prior art with respect to the closures is that the closure angle of rotation feature is difficult to detect. For this purpose, there are many approaches in the prior art, but none is easy to manage in practice. There is no true 100% and 100% reliable inline inspection.

Usually, an off-line check on a sampled quantity in the laboratory is subsequently carried out by human hands.

The disadvantage of the prior art with respect to the containers is that the container marking must be visible from above so that, at best, it can be detected simultaneously with the closure marking. This applies to both offline and inline controls.

It is further disadvantageous in the prior art that there is a conflict of interest for the distributors, those who fill the containers. On the one hand, the relative measurement of the two markings on 100% of the produced containers is desired, and on the other hand both markings should be placed to be as inconspicuous as possible to the consumer of the containers.

A disadvantage of the prior art is the container marking applied to the support ring. In order to conserve plastics material for resource and environmental reasons, the support ring is often designed to be very weak, narrow and, if possible, with a small diameter. The support ring diameter is often identical to the closure diameter. However, the support ring would have to protrude significantly beyond the closure so that the mark could be detected from above or obliquely from above together with the closure marking.

In the meantime, there is a new type of closure, the so-called tethered caps (closures which remain firmly connected to the container after opening). These have in common is that, in whatever form, they have a kind of lasso function. This function causes the closure to remain connected to the container via the lasso, in particular to the retaining ring on the container, even after opening.

By way of example, a closure and mouthpiece combination is applied correctly in the 660°-790° angular range. The angle is measured by the threading position, the beginning of the thread at the mouthpiece.

The closure process can require additional water in many ways, two examples: one to reduce the friction. In this case, the thread of the mouthpiece is moistened with water. This facilitates the screw-on operation. Another time, the closed container is rinsed in, the mouth region with water to rinse out any sugary product residue. Without this, mold would develop over time in the region between the mouthpiece and the closure.

Closure devices known from the prior art for closing the containers apply the closures to the containers. The closure devices often have several closure units which (continuously) apply closures to a mouthpiece or a mouth region of the container.

A disadvantage of the prior art is that additional water is always applied in the closure region. Immediately after closing, said water settles in drop form on the support ring and covers the marking there. Or water drops are detected as pseudo markings and misinterpreted.

A disadvantage of the prior art is that the water drops would have to be removed completely. A high expense in terms of technology and energy, e.g., by a blowing device.

The disadvantage of the prior art is the limited applicability in practice as an inline quality measurement.

A disadvantage of the prior art with respect to the multipart threads is that, for example, there are 3 threading positions in the 3-part thread and thus, in the closed state, three different relative positions with the grid 0°/120°/240°. The uniqueness or the measurement reliability shrinks.

The disadvantage of the prior art is the manual checking of the results in the laboratory. This results in a disadvantageous time delay between a malfunction and a possible intervention.

Within a closure shape, the closure function needs to be checked from time to time. In general, the closed container is checked for correctness at fixed time intervals or after a specific production quantity in the laboratory. If the result is rejected, the closure head must be readjusted.

Disadvantageously, the readjustment at that time is comparatively time-consuming. The requirement for regular maintenance of the closure device is also disadvantageous for the operator.

Closures with the same shape but different colors have different coefficients of friction. The base material of the closure is the same, so that the deviating friction can be attributed to the addition of color and other additives. This behavior has an influence on the closing angle with the same closure shape but a different color.

This is therefore made this way because during application, for example, in both cases the friction is reduced by moistening in order to facilitate the process. The whole thing has an impact on the end consumer. The differing friction is at work here and, with the same closing angle, would result in containers that are difficult or easy to open. If the closing angle is adapted to the friction, the opening remains independent thereof.

A disadvantage of the prior art is the differing screw-on behavior for a different closure color.

The closure color A with lower friction tends to achieve a higher closure angle than the closure color B with higher friction. It reaches a lower closure angle. The closure angle is set via the limit torque at which the screwing process stops. It may be that just because the closure color is different, a new closure program with a different limit torque needs to be created and changed to this during the production of the color. If there are fundamental changes to the limit torque after an overhaul, all types must be readjusted.

The object of the present invention is to overcome the disadvantages known from the prior art and to provide a method and an inspection apparatus for inspecting containers provided with closures, as well as a method and a closure apparatus for closing containers with closures which, to the highest degree, provide closure processes which are extremely accurate and reliable and equally user-friendly and can be flexibly adapted to the closure types and/or container types and also provide for the testing thereof by inspection of the containers provided with closures.

### SUMMARY OF THE INVENTION

In a method according to the invention for inspecting containers provided with closures for checking a sealing function between the closure and a container provided therewith, wherein the closure is arranged by arrangement in the closure direction at a mouth region of the container, the containers, in particular as a container stream, are transported (continuously) by means of a transport device on a single track along a predefined transport path. In particular, the method serves to check for a correct closure process (carried out by a closure apparatus described below). The containers are preferably filled containers.

The containers are preferably plastics material containers (in particular PET containers), containers whose main component consists of pulp and/or glass containers. The containers may be containers from the beverage and/or food and/or cosmetics industries. For example, they may be bottles, such as glass bottles, pulp bottles and plastics material bottles.

The closures preferably have a cap portion and a circumferential wall surrounding a closure direction and/or a mouth and/or a mouthpiece of the containers and/or a mouth region of the containers. Preferably, the cap portion and/or a cross-section through the closure is substantially circular or in a circular line shape. The closure direction preferably extends through the center point of the circle or the circular line. The closure direction preferably extends along a direction of a normal formed relative to the cap element.

Preferably, the closure direction is the straight-line direction in which the closure has to be moved toward the container in order to close the container (while rotary movements are possibly moving). The closure direction preferably extends along the longitudinal direction of the container. The longitudinal direction of the container is preferably a main extension direction. The longitudinal direction preferably extends along a central axis of the container, in particular of the main body and/or of the container opening and/or of the mouth region of the container.

Preferably, when viewed in the longitudinal direction of the container, the mouth region is arranged above a bottom and/or standing region of the container.

Particularly preferably, the circumferential wall has an internal thread on its inner surface which can be screwed onto an external thread of the container.

The mouth region of the containers has in particular the container regions forming an opening of the container, in particular a mouthpiece of the container. The mouth region preferably also has an adjoining region of a support ring and/or of a container neck.

The mouth region is preferably the container area that is not deformed and/or not stretched during the manufacturing process of the container, in particular the blow molding process of the container (from a preform).

The mouth region preferably has a (preferably rotationally symmetrical) region, when viewed in the longitudinal direction, below and/or in the direction of the bottom region, adjoining the support ring, which in particular transitions beyond a (full) circumferential bend and/or edge into a further container section, such as a shoulder area and/or a region that widens in the radial direction in relation to the longitudinal direction (when viewing a surface profile that extends counter to the longitudinal direction). Preferably, the bend or the edge is a delimitation of the main body of the container stretched during the blow molding process and of the region not stretched during the blow molding process.

The inspection method is preferably carried out by an inspection apparatus described in a subsequent section.

The method preferably comprises that, preferably during this transport, the containers provided with the closures are illuminated by a lighting device at least in regions.

The method comprises that at least one image recording device, preferably a plurality of image recording devices, records at least one spatially resolved image (and preferably a plurality of spatially resolved images) of the container to be inspected that is provided with the closure.

It is preferred that the plurality of image recording devices in each case records (at least or exactly) one spatially resolved image. However, it is also conceivable for the plurality of image recording devices to (jointly) record the at least one image which is composed (for example by stitching and/or matching) of the images respectively recorded individually by the image recording devices. It is also conceivable in principle that, by means of a precisely determined and fixed (and known) calibration of the image recording devices relative to one another and/or relative to the container, also a relative position of the closure relative to the container can be determined from the spatially resolved images recorded from at least two different image recording devices (from the image aggregated from several images), if the at least two spatially resolved images (or each of these images) do not necessarily represent both the container and the closure.

The following description is provided in relation to the “at least one (spatially resolved) image.” This is to be understood in particular in such a way that it is a (spatially resolved) image resulting from a single image or composed or aggregated from several single images (from one image recording device or the plurality of image recording devices).

The plurality of image recording devices (preferably two or four image recording devices) can thereby record the corresponding spatially resolved image substantially at the same time (or offset only by their flash lamp use) and/or within a time interval of less than 1 s, preferably less than 0.5 s and particularly preferably less than 0.3 s, preferably less than 0.2 s, preferably less than 0.1 s. In particular, it is proposed to carry out the recognition and/or the detection using at least two image recording devices, in particular cameras. Two or four cameras are optimal, but there can also be three or more than four.

In a further preferred method, in the (preferably each) at least one image recording device (for recording one and preferably each spatially resolved image), a flash time or exposure time of a sensor of the image recording device is set (and/or adjustable) and/or is used which is less than 150 μs, further preferably less than 100 μs, particularly preferably less than 50 μs.

The intersection of the (flash/) lighting time and the exposure time of the sensor results in the effective scene exposure, which is frozen in an image. Because the container and the closure are moved continuously during the recording, it must be short corresponding to the requirements (comparable to a preset known as a so called “sports shot”).

Preferably, the flash time or exposure time of a sensor of the image recording device in each image recording device takes place separately within 0.5 s, preferably within 0.3 s, preferably within 0.2 s and particularly preferably within 0.1 s (which are preferably proposed above as the time interval for recording the images as preferred embodiments).

If several image recording devices (preferably 2 or 4 image recording devices) are present, these (preferably 2 or 4 image recording devices) can perform the effective scene exposure synchronously with one another.

In a further preferred method, at least one second image recording device records at least one spatially resolved image of a portion of the circumferential edge and/or a portion of the container, in particular of a rotationally symmetrical element. In this method, at least two image recording devices are used.

For checking the sealing function, the at least one spatially resolved image (preferably a plurality of spatially resolved images) is recorded (optically) according to the invention by the at least one image recording device, preferably by the plurality of image recording devices, in such a way that a relative position of the closure, when viewed in (the) closure direction in relation to the container provided therewith, is thereby depicted.

In other words, image data are detected or recorded (by means of the at least one image recording device) which are characteristic of a viewed (and/or present) relative position of the closure in the closure direction relative to the container which is provided with the closure. In other words, image data are detected or recorded (by means of the at least one image recording device) which are characteristic of a distance between the closure and the container extending in the closure direction, in particular between the closure and a reference region of the container.

It is thus conceivable that the relative position to be depicted relates exclusively to a component of the relative position of the closure relative to the container which (substantially) runs exclusively along the closure direction.

Preferably, the closure is depicted by the image recording and/or preferably in the recorded at least one spatially resolved image (at least in portions and preferably at least completely in the closure direction and/or longitudinal direction).

Preferably, a portion of the container, in particular of a mouth region and/or of an upper region of the container in relation to the container bottom (and/or in relation to a wall region of the container opposite the mouth region) when viewed in the longitudinal direction and/or counter to the closure direction, is depicted by the image recording and/or preferably in the recorded at least one spatially resolved image.

A portion of the circumferential wall of the closure and/or of the container is preferably depicted by the image recording and/or preferably in the recorded at least one spatially resolved image, which portion extends in the circumferential direction (with respect to the closure direction and/or the longitudinal direction of the container) over an angle of at least 30°, preferably at least 50°, preferably at least 60°, preferably at least 90°, preferably at least 120°, preferably at least 180°, preferably at least 220°, preferably at least 270°, preferably at least 300°, preferably at least 330°, and preferably (substantially) 360° (over the entire circumference). The circumferential direction corresponds in particular to a direction of rotation about the closure direction and/or the longitudinal direction of the container. The specified (extension) angles correspond in particular to angles of rotation about the closure direction and/or longitudinal direction of the container.

The relative position depicted in the image recording of the at least one spatially resolved image and depicted in the recorded (then by the at least one image recording device) spatially resolved image can be a distance viewed in the closing direction and/or present between the closure and the container provided therewith. In other words, a spatially resolved image is recorded in such a way that a distance seen in the closure direction (in particular exclusively) can be seen between the closure and a reference region of the container.

According to the invention, an image evaluation device, in particular a processor-based image evaluation device (in particular in a computer-implemented step), determines at least one sealing variable that is characteristic of performing the sealing function on the basis of the relative position depicted in the at least one spatially resolved image. The image evaluation preferably processes the at least one spatially resolved image and thereby determines the sealing variable.

The sealing variable is preferably used in order to evaluate and/or check a correct seating of the closure on the container, in particular a position of the closure in the longitudinal direction and/or closure direction relative to the container.

Preferably, the containers provided with the closures are continuously inspected and at least one sealing variable (as described above) is determined for each container provided with a closure (preferably in real time) that is inspected. The following description and preferred embodiments are described only in relation to a container provided with a closure. It goes without saying that the description preferably applies to each container that is inspected (in succession).

In other words, the proposed method proposes a determination of a sealing function that is not based on markings on the container (provided for marking a closure angle of rotation) or on the closure, but instead advantageously dispenses with these. In particular, the proposed method relates to a marker-less measurement of closure rotation angle (which is indicative of a rotational position).

It is preferably proposed to measure the sealing function of the closure and the mouthpiece (of the container) not via the closure rotation angle, but rather via the distance of the closure at its actual positions from the mouthpiece from the outside at its actual positions.

In particular, the two positions (of the closure and of the mouthpiece) are brought into relation.

The features of the mouthpiece and or the features of the closure are preferably spatially detected.

Particularly preferably, the distance of the closure and of the mouthpiece is spatially detected (in particular by means of image recording and evaluation of the at least one spatially resolved image).

In a preferred method, the determined sealing variable is characteristic of an, in particular maximum, distance between a sealing region provided for performing the sealing function on the closure (such as sealing lips), and a corresponding sealing region provided for performing the sealing function on the container, in particular an front face of a mouth region of the container. This offers the advantage that a sealing effect or a performing of the sealing function can be derived from this distance.

Further advantageously, starting from this distance, it can be determined whether and to what extent the closure has to be moved toward the container (even further) in the closure direction in order to perform a desired and/or optimal sealing effect or to ensure an implementation of the sealing function. Advantageously in the case of screw closures, the torque with which the closure still needs to be screwed onto the mouth region in order to achieve an intended sealing effect and/or to perform the sealing function can be determined. It is also conceivable that the total torque—and/or how a total torque (applied in the closure apparatus during this closure process) needs to be changed in order to apply a similar closure to a similar container with the desired result—is determined.

The distance is preferably a distance in the longitudinal direction and/or the closure direction. For example, a sealing region can be arranged on the inner surface of the cap element of the closure. The corresponding sealing region can be arranged on the front side of the mouth region of the container. In this case, an insertion depth of the mouth region into the closure and/or a screw-on depth of the closure onto the mouthpiece or onto the mouth region can be determined or derived (substantially) directly from a distance that is determined (in the longitudinal direction or closure direction) between the closure and the container (because the corresponding changes of these distances are the same when the closure is moved relative to the container in the closure direction).

However, it is also conceivable for at least one corresponding sealing region to be arranged on the container or on the closure laterally on the mouth region or on the (circumferential) inner wall of the circumferential wall of the closure. According to the geometric design of the closure and the mouth region of the container, this distance also correlates in particular to the distance between the closure and the container, so that a performing of the sealing function can also advantageously be assessed here by determining a distance between the closure and the container.

On the basis of the relative position depicted in the at least one spatially resolved image, the image evaluation device preferably determines (in particular in a computer-implemented step) at least one distance variable that is characteristic of the relative position (for example, a distance value). This can be a distance between the closure and the container viewed (in particular exclusively) in the closure direction and/or longitudinal direction, in particular between a reference region on the closure and a reference region on the container.

It is conceivable that the image evaluation device determines the sealing variable from the distance variable that is characteristic of the relative position.

On the basis of the relative position depicted in the at least one spatially resolved image, the image evaluation device preferably determines (in particular in a computer-implemented step) at least one attachment variable which is characteristic of an insertion depth of the mouth region into the closure and/or a screw-on depth of the closure onto the mouthpiece or onto the mouth region. In particular, by determining an insertion depth of the mouth region into the closure and/or a screw-on depth of the closure onto the mouthpiece or onto the mouth region, the distance between the corresponding sealing regions of the closure and the container can be deduced. Advantageously, starting from the attachment variable, it can be assessed whether a sealing effect is already ensured to a sufficient extent and/or whether, and how far, the closure is further to be moved toward (and applied to) the container in order to perform the sealing function.

The attachment variable can also be a characteristic closure rotation angle variable for a closure rotation angle by which the closure was rotated onto the mouth area of the container (for example in the case of closures designed as screw closures) in the context of a screwing process of the closure onto the mouth region of the container (to position the closure in the closure direction). Furthermore, the attachment variable can additionally or alternatively be a characteristic variable of a relative rotational position of the closure relative to the container. The determination of such closure rotation angle variables or characteristic variables of the relative rotation position (which can preferably be used as attachment variables) are described in more detail in a subsequent section in the context of a second method for inspecting containers provided with closures in order to check a sealing function between the closure and the container connected thereto.

Preferably, the sealing variable is determined from the attachment variable.

In particular, the proposed method makes it possible to reliably determine the screw-on depth of the closure onto the mouthpiece. The detection of auxiliary markings which indirectly represent the distance of the closure relative to the mouthpiece by an angle of rotation is not necessary.

Advantageously, therefore, closures and container mouthpieces, especially the support ring diameter, can be designed as desired. There is no need to consider the visibility of the markings.

The support ring in the diameter can advantageously be reduced in favor of savings of plastics material. The visibility of the auxiliary marking is no longer required.

Preferably, several relative positions of the closure relative to the container are depicted in the at least one image (in particular seen in the circumferential direction) and a sealing variable and/or a distance variable are determined therefrom (by the image evaluation device). Preferably, a (common) sealing variable and/or a (common) distance variable is determined from the several (depicted) relative positions.

Advantageously, the influence of system-related water is minimized, because in particular the presence of individual drops at individual points for determining the insertion depth or screw-on depth can be compensated for by further regions.

The effort of blowing it off is advantageously minimized.

Result of the test: in standard closures, a measurement accuracy of approximately 30 μm at sigma=3. This corresponds to an angular resolution of 5.5° at a thread pitch of 2.0 mm. In this example, a repeat accuracy of 10 μm was achieved at sigma=1.

In a further preferred method, the (depicted) relative position (of the closure with respect to the container provided therewith) is a relative position of a region of the closure which is designed to be rigid in the closure direction in order to perform the closing function, or a feature associated therewith which is present in a positionally fixed manner in the closure direction (and is present on the closure) relative to the container. In order for the sealing function of the closure to be able to reliably engage in the mouthpiece and/or into the mouth region, both the mouthpiece or the mouth region and the closure cap are preferably designed to be rigid in the axial direction. The choice of regions connected in a fixed position to rigid regions therefore offers a precise assessment of a performing of the sealing function.

Alternatively or additionally, the (depicted) relative position (of the closure with respect to the container provided therewith) is a relative position of the closure with respect to a region of the container which is rigid in the closure direction in order to perform the closing function, or is a feature which is associated herewith in a fixed position in the closure direction (and present on the container). Here too, the choice of regions connected in a fixed position to rigid regions offers a precise assessment of a performing of the sealing function.

The aforementioned rigid regions are preferably more rigid than further regions of the closure and/or of the container.

The rigidity of the mentioned regions is preferably brought about by a wall thickness that is increased compared to further regions of the closure and/or container.

In a further preferred method, the relative position is a relative position in relation to at least one outer feature, preferably present on the circumferential wall of the closure. The feature is preferably formed by a texture present on the closure, in particular on the circumferential wall. The feature preferably performs a further function that is different from the determination of a rotational position of the closure (such as easier opening).

This offers the advantage that a feature already present in any case is used to check the sealing of the closure, and no additional element which is evaluated by the end consumer as visually unfavorable is required for marking a relative rotational position. Preferably, at least one feature identical to the at least one feature is present which is arranged symmetrically with respect to a longitudinal sectional plane through the closure.

The aforementioned texture can particularly preferably be a texture which results from an (in particular vertical) projection or an (in particular vertical) elevation, a plurality of (in particular vertical) projections or (in particular vertical) elevations and/or an (in particular vertical) depression. These can, for example, be distributed uniformly (in a predefined manner) over the circumferential edge.

The at least one feature can be a feature facilitating the opening of the container.

Preferably, the feature is preferably selected from a group comprising features which are formed by a knurled texture, several knurled textures, a perforation region, in particular as a boundary for the locking ring, one or more bends, a groove, several grooves, a circumferential edge, a feature which is designed to be continuously or discretely rotationally symmetrical with respect to the closure direction, and the like, and combinations thereof.

These features are preferably present on the outer circumferential wall. Preferably, the at least one feature is depicted by image recording of the outer circumferential wall (in the at least one spatially resolved image).

In a further preferred method, the relative position is a relative position with respect to a rotationally symmetrical element (of the container) arranged in a region of the mouth of the container, in particular a support ring, a support ring underside, a support ring outer edge, a bend between the support ring and a stretchable and/or stretched region of the container and/or a boundary line between an stretched and an unstretched region of the container (in each case as a reference region on the container).

These reference regions are, in particular, features which are visually comparatively easy to detect, in particular because they extend over the entire circumference of the circumferential wall and/or because they are comparatively strongly delimited by the adjacent regions (comparatively large projection of the support ring with respect to the surrounding surface regions, clear bend between support ring and a stretchable and/or stretched region of the container with a comparatively large bending angle).

The sealing variable and/or the distance variable and/or the attachment variable and/or a variable that is characteristic of the insertion depth and/or the screw-on depth is preferably determined on the basis of several features depicted in the at least one spatially resolved image and/or several reference regions depicted in the at least one spatially resolved image on the container.

The sealing variable and/or the distance variable and/or the attachment variable and/or a variable that is characteristic of the insertion depth and/or the screw-on depth is preferably determined using an image evaluation model, in particular a trainable machine learning image evaluation model, which comprises a set in particular of trainable parameters which are set to values which have been learned as a result of a training process.

The machine learning image evaluation model is preferably based on an (artificial) neural network. The neural network is preferably designed as a deep neural network (DNN), in which the parameterizable processing chain has a plurality of processing layers, and/or a so called convolutional neural network (CNN) and/or a recurrent neural network (RNN).

The data (to be processed), in particular the spatially resolved images (or data derived therefrom), are preferably supplied as input variables to the image evaluation model or the (artificial) neural network. The image evaluation model or the artificial neural network preferably forms the input variables depending on a parameterizable processing chain to output variables, wherein the sealing variable and/or the distance variable and/or the attachment variable and/or a variable that is characteristic of the insertion depth and/or the screw-on depth are preferably selected as output variables.

The machine learning image evaluation model is preferably trained using predefined training data, wherein the parameterizable processing chain is parameterizable by the training.

In a preferred method, training data comprising a plurality of spatially resolved images (of containers provided with closures) captured by the at least one image recording device are used in the training process of the image evaluation model. This offers the advantage that the training process is already specifically matched to the inspection device to be set and thus, for example, specific circumstances of the specific container inspection apparatus, such as optical properties of the image recording device or also specific light conditions in the inspection apparatus, can thus be directly taken into account.

The spatially resolved images (recorded by the at least one image recording device) provided for use as training data are preferably provided with (container) type and/or classification features.

Preferably, the spatially resolved images are stored and/or used as a training data set (in particular on a and/or the non-volatile memory apparatus), together with the container types and/or closure types and/or features that are characteristic for a closure composition (addition of color, additives, in particular friction influencing components) which are assigned thereto. A plurality of training data sets is preferably generated in this way.

The classification features can preferably be the sealing variable and/or the distance variable and/or the attachment variable and/or a variable that is characteristic of the insertion depth and/or the screw-on depth.

By using a machine learning image evaluation model, it is achieved that a (complex) combination of different features and/or reference regions (in the training process) that is optimal for data processing and features (or combinations of features) adapted to different closure types and/or container types is identified or determined.

This offers the advantage that, when evaluating the at least one spatially resolved image, the sealing variable and/or the distance variable and/or the attachment variable and/or a variable that is characteristic of the insertion depth and/or the screw-on depth can then be determined with high precision by means of the trained image evaluation model.

In a further preferred method, the at least one (preferably each) image recording device records the containers from a direction which forms an angle of at most 60°, preferably at most 30°, preferably an angle of substantially 0°, and particularly preferably an angle between 5° and 15°, with a horizontal plane perpendicular to the longitudinal direction of the container and/or with a horizontal plane perpendicular to the closure direction.

The container is upright on the (transport) belt (in space). The horizontal plane here is in particular parallel to the (transport) belt (plane) on which the container stands upright. The image recording device viewing axis (preferably camera viewing axis) and/or image recording axis of the at least one (preferably each) image recording device assumes a downwardly inclined direction relative to the horizontal plane. That is to say, the at least one (preferably each) image recording device (preferably camera) looks at the closure and container not horizontally, but with a slightly lowered view. The angle between the horizontal plane and the image recording device(s) (preferably the camera(s)) is preferably at most 60° downward, preferably at most 30° downward, particularly preferably at 5°-15° downward.

Preferably, the at least one image recording device is and, particularly preferably, the image recording devices (preferably all) are arranged above the container (to be inspected). Preferably, the at least one image recording device and particularly preferably the (preferably all) image recording devices are arranged in a horizontal plane (perpendicular to the longitudinal direction and/or closure direction of the container) (in the longitudinal direction of the container to be inspected, viewed from a bottom region of the container in the direction of the mouth region of the container) above the container (to be inspected).

Preferably, the at least one image recording device is-preferably the image recording devices are—arranged (therefore in sequence) closer to the mouth of the container than to the bottom region of the container. The image recording axis of the at least one (preferably each) image recording device preferably forms an angle of inclination of at most 60°, preferably at most 30°, and particularly preferably an angle of inclination between 5° and 15° with the horizontal plane.

Preferably, the image recording axis of the (corresponding) image recording device is inclined downward and/or (downward) toward the mouth of the container starting from the image recording device in the direction of the object (in this case container) to be recorded by the image recording device, or in the direction of the inspection position (viewed from the container bottom in the direction of the container mouth in relation to the longitudinal direction of the container).

A (substantially) horizontal image recording direction (horizontal view of the image recording device), in which the image recording device records the containers from an image recording direction, which is arranged (substantially) parallel to the horizontal plane (perpendicular to the longitudinal direction and/or closure direction), i.e., forms an angle of substantially 0° with the horizontal plane, is also preferably conceivable.

The camera viewing axis or the image recording direction (or image recording axis) of an (each) image recording device and the container/closure axis (or longitudinal axis) do not necessarily have to intersect. The camera or image recording apparatus can also miss the mark. In practice, they always do, because the container is recorded (preferably) during transport and rarely assumes the ideal position. In particular, the image recording apparatuses or camera(s) always look awry to a slight degree, because the alignment is never perfect. This is preferably compensated by a calibration (already mentioned above). Preferably, the image recording device (camera) should not go past the container/closure axis (or longitudinal axis of the container) by more than +/−20°, particularly preferably not more than 3°.

Preferably, a (preferably diffuse), in particular flat, scattering element is arranged on a (each) image recording device and preferably extends along a plane perpendicular to the image recording axis or image capture and/or (in particular completely) around the image recording axis. This scattering element preferably serves as a corresponding background for an (each) opposite image recording device. The scattering element preferably has an opening through which the image recording axis of the corresponding image recording device extends. This opening is preferably an opening for a lens of the image recording device. In order for the respectively opposite image recording device to record not the opening of the scattering element (as the background) but the (diffuse) scattering element during the image recording, an angle of inclination of 15-30° is preferably selected for the arrangement of the (each) image recording device.

In a further preferred method, the at least one spatially resolved image, preferably a plurality of spatially resolved images, of at least two, preferably at least three, preferably at least four, preferably more than four image recording devices and particularly preferably two or four image recording devices is recorded. The image recording devices preferably each record a portion of the circumferential edge and/or at least one portion of the rotationally symmetrical element (support ring).

In a further preferred method, the determined sealing variable, which is preferably characteristic of an arrangement depth, in particular a screw-on depth, of the closure in relation to the container, is provided for transmission to a closure apparatus for closing containers with closures. The determined sealing variable is preferably transmitted to the closure apparatus. This offers the advantage that a feedback of the measurement results is provided for the closure apparatus.

It is preferably proposed to report the screw-on depth back to the closure device. This offers the advantage that it can be compared to an applied torque.

It is advantageous here to determine a collective value over a specific number of measurements (in particular the determined sealing variable, which is preferably characteristic of an arrangement depth, in particular a screw-on depth, of the closure with respect to the container). The collective value can be a mean value, a representative value, or a value which cuts down on or discards measurement outliers, for example. It is helpful to form a variance measure, a deviation, etc. This offers the advantage of as precise setting as possible of the closure apparatus and the closure process carried out thereby and the most precise possible adaptation of the closure process to the types of the closure (for example, its color and/or composition and/or friction values).

In a further preferred method, the determined sealing variable, which is preferably characteristic for an arrangement depth, in particular a screw-on depth, of the closure in relation to the container, is transmitted to the closure apparatus for closing containers with closures in order to regulate the closure apparatus. Preferably, the determined sealing variable is transmitted to the closure apparatus (in particular to the control thereof) at regular time intervals and/or continuously and/or for each container provided with a closure that is inspected. The determined sealing variable (or a variable derived therefrom), in particular of the closure apparatus, is preferably compared to an applied torque. A nominal variable is preferably derived therefrom. This offers the advantage of control or provision of a closed loop.

In particular, changes in the closure process are advantageously reliably detected.

In a further preferred method, a color variable that is characteristic of a closure color and/or a color friction variable which is characteristic of a color friction and/or an ambient temperature variable which is characteristic of an ambient temperature value is determined and/or provided for transmission to a closure apparatus for closing containers with closures.

In particular, it is proposed to additionally report back the closure color. It is advantageous here to determine a collective value over a specific number of measurements (of the closure color), in particular by individual types. The collective value can be its mean value, a representative value, a value that reduces or discards measurement outliers, for example. It is helpful to form a variance measure, a deviation, etc.

It is preferably proposed to additionally determine and report back the ambient temperature. Here too, a collective value and/or a variance measure can be formed (and transmitted and/or stored) via a specific number of measurements.

It is preferably proposed that the screw-on depth, preferably additionally the closure color, or alternatively a color friction correction value, additionally transmit the ambient temperature.

The inspection and control method proposed here takes advantage of the fact that the use of a new closure color, the changed coefficient of friction, has no influence on the screw-on height.

Therefore, the method for inspection can preferably be carry out an adjustment of the (total) torque to be applied by the closure apparatus during the closure process by reporting back the corresponding screw-on height (and/or sealing variable and/or insertion depth and/or screw-on depth) or a variable derived therefrom or characteristic thereof and a control and/or regulation of the closure device based thereon without intervention by an operator. This offers the advantage that a new composition of the closure influencing a new color and/or the friction can be automatically performed based on the provided and transmitted sealing variable.

A diffuse incident light method is preferably used in each case for inspecting the closures.

The closures are preferably illuminated from above for inspection. The inspection apparatus preferably has a lighting device which is arranged above the containers which are to be inspected and are provided with closures and/or which lighting device is suitable and intended for illuminating the closures from above. A diameter of the lighting device can be, for example, greater than 150 mm, preferably greater than 220 mm, and particularly preferably greater than 280 mm.

The lighting device is preferably suitable and intended for illuminating the containers (to be inspected) that are provided with closures (when they are arranged in the inspection position) diffusely from above, so that the closure and the container geometry (support ring, shoulder region of the container, . . . ) are preferably illuminated uniformly. The lighting device is preferably arranged and designed in such a way that the light emitted by the lighting device (from above) produces shiny points on the elevations and/or shadows on the depressions. The lighting device, particularly preferably additionally, is preferably arranged and designed in such a way that the light emitted by the lighting device generates a uniform basic lighting (of the container provided with the closure) from further outside.

The lighting device preferably has a lamp surface which particularly preferably forms a conical light shield. In particular, in a preferred embodiment, no image recording device can be arranged in the center of the cone (of the lighting screen). It is conceivable that a (further) image recording device (in particular a camera), which, for example, checks the closure (cap) for a correct label, can be arranged in the cone center (of the lighting screen).

The lighting screen is preferably configured and/or designed as a flat pane. This embodiment is preferred in the case that no image recording device (such as a camera) is provided or arranged (centrally or in the middle) above the container (to be inspected) which is provided with a closure (for example, an image recording device that is suitable and/or intended for closure checking).

Particularly preferably, the container and the closure are illuminated with white light and in particular with white light LEDs (as the lighting device). Particularly preferably, a flash lamp is used as the lighting device. Preferably, the image recording (particularly preferably of all image recording devices) is triggered to illumination. Particularly preferably, the image recording (in particular of all image recording devices) is also triggered—for example, with a light barrier.

In a particularly preferred method, grayscale images or color(˜coded) images are recorded. In a further advantageous method, at least one color-coded image and preferably a plurality of color-coded images is recorded.

Particularly preferably, at least one measure for increasing the contrast of the recorded images is carried out. Particularly preferably, said at least one measure is selected from a group of measures including processing and, in particular, preprocessing of the at least one spatially resolved image in a brightness channel, processing and, in particular, preprocessing of the at least one spatially resolved image in a complementary channel, processing and, in particular, preprocessing of the at least one spatially resolved image in a saturation channel, combinations of these measures and the like.

These described methods are generally suitable for all types of closures, which is particularly advantageous. The closure is preferably selected from a group of closures, which contains closures for the one hand use, flat caps, sports caps, tethered caps, multi-part closures, push-pull closures, snap closures, screw closures, crown cork closures (the crown caps and the sheet edge in relation to the mouthpiece of the container also indicate the sealing) and the like. Particularly preferred, however, are closures that are seated on the external threads of the container.

It is further advantageous that multipart threads can be reliably processed by the proposed methods. The ambiguity of the closure angle is eliminated by the proposed evaluation of the relative position of the closure relative to the container (viewed in the longitudinal direction and/or closure direction).

In addition, the closures may also be closures formed with or without a dust cap and/or with or without a tamper-evident band or a securing band for detecting an initial opening.

Particularly advantageously, the method can be used if the closure has a (continuously) rotationally symmetric design, i.e., it does maintain the same outer section shape in all vertical sections.

The method can particularly advantageously be applied if the closure and/or the container, in particular the support ring of the container, (in particular on the regions thereof that can be inspected from the outside) does not have a marking which in particular defines a unique rotational position of the closure or of the container.

In a particularly preferred method, the containers, in particular as a container flow, are transported along a straight or circular transport path during their inspection, and in particular along a straight transport path.

Preferably, the container flow is an (in particular continuous) flow (on the transport path) of successive or consecutive containers. In this case, the container flow can be guided or transported in regions and preferably within the entire inspection apparatus (as a mass flow) in a single track or on multiple tracks (by means of the transport device). Preferably, at least one image recording device is assigned to a track of the container flow and detects each container of the container flow located on this track.

A transport apparatus is preferably used which transports at least 5000 containers to be inspected per hour (toward the image recording device and away from it) or is suitable and intended for this purpose.

The image recording device and the plurality of image recording devices (in particular cameras) and the arrangement of the image recording devices (in particular cameras) are preferably calibrated. Imaging parameters are preferably determined by calibration.

The present invention is further directed to a method for inspecting containers provided with closures for checking a sealing function between the closure and a container provided therewith. By performing a screwing-on process, the closure is arranged on a mouth region of the container and thereby arranged a closing direction on a mouth region of the container.

In particular, the closure is a screw closure which can be screwed onto an (outer) thread of an opening region. The screw closure in particular has an internal thread corresponding thereto. The (outer) thread (and/or the internal thread of the closure) preferably has a thread with a fixed and/or constant thread pitch.

In this case, the containers are transported along a predetermined transport path by means of a transport device, and during this transport, the containers provided with the closures are illuminated at least in regions by a lighting device, and at least one image recording device records at least one spatially resolved image of the container to be inspected which is provided with the closure.

According to the invention, to check the sealing function, at least one spatially resolved image is recorded by the at least one image recording device in such a way that a relative position of the closure in the closure direction relative to the container provided therewith is thereby depicted, in particular a distance between the closure and the container, as viewed in the closure direction.

According to the invention, an image evaluation device determines (preferably exclusively), on the basis of the relative position depicted in the at least one spatially resolved image for checking the sealing function, at least one closure rotation angle variable characteristic of a closure rotation angle about which the closure was rotated (starting from an initial and/or threading (rotation) position), in particular about the closure direction and/or longitudinal direction of the container, as part of the performed screwing-on operation. Preferably, in particular, no markings are used on the closure or the container that allow the identification of a rotational position of the closure and/or the container.

In other words, the closure rotation angle variable can be a closure rotation angle (or a variable characteristic thereof) by which the closure was rotated relative to the container (in particular to the mouth region of the container) during the screwing-on operation. In this case, the closure rotation angle can relate to a (relative) rotational position of the closure in relation to a starting and/or threading (rotational) position of the closure relative to the container. The threading (rotational) position is fixed, and preferably clearly predetermined, preferably by the design of the mouth region and/or of an (outer and/or internal) thread of the closure or of the container.

Preferably, at least one sealing variable characteristic of a fulfillment of the sealing function is determined depending on the determined closure rotation angle variable.

The proposed method offers the advantage that the determined closure rotational angle variable can be used to check the sealing function of the closure on the container. In this case, the determination thereof is based in particular exclusively on an evaluation of a screw-on depth of the closure on the container, and is therefore advantageously independent, for example, of different friction values, which can result from different closure colors of closures of an otherwise identical closure type. The proposed method offers the advantage of providing a particularly accurate determination of the closure rotational angle variable which, in particular in comparison with the determination methods known in the prior art, has very small measurement inaccuracies.

In this case, the method can comprise all the method steps described above in connection with the method for inspecting containers provided with closures (individually or in combination with one another) (and vice versa). In particular, all elements, devices, and apparatuses, and terms which are mentioned within the scope of the method described here, can have features, embodiments, properties, and characterizations which have been described in connection with the above-described method. In particular, identically named terms can be elements/devices or variables that are identical or have the same effect.

The method preferably comprises the above-described method (according to one or more preferred embodiments). In particular, the method (in particular as the first of two stages) comprises a recording and evaluation of the at least one recorded spatially resolved image and/or a determination of a sealing variable performed in the method described above.

The method is preferably a two-stage method in which, in a first stage, the closure rotation angle variable is determined, and in a second stage, the closure rotation angle is further specified or finely determined on the basis of the closure rotation angle determined in the first stage.

In a preferred method, at least one expected variable characteristic of an expected region on the container and/or on the closure is determined depending on the determined closure rotation angle variable, in which a marking element is arranged on the container and/or the closure that is suitable and intended for, in particular, a clear identification of a rotational position of the container and/or closure.

This offers the advantage that a region to be examined in which the marking element is sought for determining a rotational position of the marking element is reduced or restricted. This offers the advantage that the risk of incorrect identification, for example, of a water drop as a marking element is considerably limited since the risk of the presence of a (randomly occurring) water drop (or another defect or interfering element impairing the optical identification) is considerably reduced by reducing the region to be evaluated (expected region).

As a result, it is advantageously possible to dispense with a blowing apparatus which alternatively could free the closed containers from the water drops impairing the measurement by blowing them off by means of a blower. This results in a considerable increase in the energy efficiency and energy saving of the inspection apparatus. Furthermore, the measurement accuracy is considerably increased.

The marking element is preferably a marking element arranged laterally or arranged on an (outer) side wall. For example, the marking element can be a notch.

In a further preferred method, depending on the at least one evaluation region is selected from at least one spatially resolved image recorded by an image evaluation device depending on the at least one expected variable characteristic of an expected region on the container and/or on the closure. Preferably, exclusively the image data of the evaluation region or variables derived therefrom are evaluated to determine a marking element.

Preferably, a panoramic image of a region of the container and/or closure is generated and, in this panoramic image, preferably an (angular) region is selected which is used to evaluate the image data in order to determine and/or recognize and/or identify the marking element in the image data (and then to determine a rotational position of the marking element). As explained above, the selection of an evaluation region offers the advantage of the considerable reduction of a measurement error and a faster processing of the data.

In a further preferred method, the expected region and/or the at least one expected variable is determined depending on a predefined and/or predefinable measurement inaccuracy of the closure rotational angle variable. Preferably, a determined measurement inaccuracy is used to establish the expected region. If, for example, the measurement inaccuracy is +/−20°, a region of the image which corresponds to the closure rotation angle +/−20° C. an be selected as the expected region. A valid determination of the position of the marking element is thereby obtained.

In a further preferred method, the expected region is a region which extends over a predetermined circumferential angle with respect to the longitudinal axis and/or to the closing direction (of the container). The expected region preferably extends in the longitudinal direction in such a way that the marking element is arranged in this region. The predefined amount of the circumferential angle is preferably established depending on a measurement inaccuracy of the determination of the closure rotation angle variable (in the first stage of the method). The exact position of the expected region is preferably defined by the determined closure rotational angle variable, in particular in relation to an initial and/or threading (rotational) position.

In a further preferred method, the circumferential angle is less than 90°, preferably less than 80°, preferably less than 60°, preferably less than 50°, preferably less than 45°, and particularly preferably substantially 40°. This offers the advantage that substantially smaller regions must therefore be used for evaluation in order to determine the (rotational) position of the marking element than in the prior art in which a region has to be examined substantially to determine the marking element (and its position determination), which region extends over a circumferential angle (with respect to a rotation about the longitudinal and/or closing direction) of 180°. In such a large region, however, the probability is considerably higher that water drops are present, and one of these will be incorrectly identified as a marking element.

The closure and the container preferably each have at least one marking element, in particular arranged on a side wall, which marking element is suitable and intended for, in particular, a unique identification of a rotational position of the container and/or closure.

In a further preferred method, these two marking elements are used to check the closure rotational angle variable and/or sealing variable determined on the basis of the relative position depicted in the at least one spatially resolved image.

In a further preferred method, the closure and the container preferably each have at least one marking element, in particular arranged on a side wall, which marking element is suitable and intended for, in particular, a unique identification of a rotational position of the container and/or closure. The position of one of the two marking elements is determined, and a rotational position of the other marking element is determined on the basis of the determined position of one of the two marking elements and on the basis of the characteristic closure rotational variable.

In a further preferred method, the position of the marking element on the closure is determined and, on the basis thereof, a relative rotational position of the marking element on the container, in particular on a support ring of the container, with respect to the marking element on the closure is determined on the basis of the determined characteristic closure rotational variable. As a result, the closure rotational angle variable determined according to the first stage of the method or the relative position determined only on the basis of the relative position (considered in the closing direction) can be further specified and/or plausibilized and/or checked.

In a further preferred method, the position of the marking element on the container, in particular on a support ring of the container (10), is determined. Preferably, a relative rotational position of the marking element on the closure with respect to the marking element on the container is determined on the basis thereof depending on the characteristic closure rotation variable. As a result, the closure rotational angle variable determined according to the first stage of the method or the relative position determined only on the basis of the relative position (considered in the closing direction) can be further specified and/or plausibilized and/or checked. Preferably, a or the (above-mentioned) sealing variable is determined depending on this (further specified and/or plausibilized) closure rotational angle variable.

In a further preferred method, at least one sealing variable characteristic of a fulfillment of the sealing function is determined from the determined relative rotational position of the marking element on the closure with respect to the marking element on the container. This advantageously determines a very valid, in particular checked, sealing variable.

In a further preferred method, a first sealing variable characteristic of a fulfillment of the sealing function and/or the closure rotation angle variable is determined without using a position of marking elements, and on the basis of the first sealing variable and/or closure rotation angle variable, a fine determination of a sealing variable and/or a fine determination of a relative rotational position of the closure with respect to the container is made using a position of marking elements on the closure and the container.

Preferably, the sealing variable (characteristic of a fulfillment of the sealing function) is characteristic of the closure rotation angle (in particular obtained from the fine determination), or of the determined and/or checked and/or (further) specified closure rotation angle variable (preferably obtained from the fine determination). Additionally or alternatively, the sealing variable is preferably characteristic of the arrangement depth of the closure in relation to the container (which in particular corresponds to the screw-on depth of the closure onto the container).

Additionally or alternatively, the sealing variable is preferably characteristic of relative rotational position of the one marking element in relation to the (respective) other marking element determined on the basis of the relative position of the closure depicted in the at least one spatially resolved image (viewed in the closing direction) relative to the container provided therewith (in particular a distance between the closure and the container viewed in the closing direction), and on the basis of the marking element of the closure, and on the basis of the marking element of the container (for the respective, in particular clear, identification of a rotational position of the closure or container).

As described in the context of the above method, this (determined) sealing variable is preferably provided for transmission to a closure device for closing containers. The determined sealing variable is preferably transmitted to the closure apparatus. This offers the advantage that a feedback of the measurement results is provided for the closure apparatus.

All methods (and apparatuses) described in connection with the sealing variable, which was determined using the above-described first method for inspecting containers provided with closures, are preferably for operating a closure apparatus and/or for controlling and/or regulating the closing process (in particular screw-on process), which is carried out by the closure apparatus, and/or all described controls and/or regulations and/or maintenance of the closure apparatus depending on an in particular trainable container-type model machine learning, also on the basis of the sealing variable described here and/or closure rotational angle variable (which, in particular according to any of the embodiments described above in the context of the second method, also preferred, also preferred embodiments described in particular for inspecting containers provided with closures), are regarded as disclosed.

In a further preferred method, the at least one image recording device records the containers from a direction which forms an angle of at most 60°, preferably at most 30°, preferably an angle of substantially 0°, and particularly preferably an angle between 5°-15°, with a horizontal plane perpendicular to the longitudinal direction of the container and/or with a horizontal plane perpendicular to the closure direction.

In a further preferred method, the at least one spatially resolved image, preferably a plurality of spatially resolved images, is recorded of at least two, preferably at least three, preferably at least four, and particularly preferably exactly two or four image recording devices.

In a further preferred method, for a plurality of containers provided with closures, wherein the closure and the container each have at least one marking element, at least one spatially resolved image is recorded in such a way that a relative position of the closure viewed in the closing direction with respect to the container provided therewith, in particular a distance viewed in the closing direction between the closure and the container, is depicted. At least one closure rotation angle variable is preferably determined in each case.

Preferably, on the basis of the plurality of at least one spatially resolved images or variables derived therefrom and on the basis of the determined closure rotation angle variables, a relationship is generated and/or determined between a relative position of the closure viewed in the closure direction with respect to the container provided therewith and the closure rotation angle variable.

In this context, it can be, for example, a database in which each relative position (viewed in the closing direction) of a plurality of different relative positions of the closure viewed in the closing direction with respect to the container provided therewith, which are stored in the database, is associated in each case with a closure rotational angle variable or a closure rotation angle. Preferably, a closure rotation angle (or a characteristic value therefor) can be called up depending on a predetermined relative position (viewed in the closing direction) (and can also be determined using mathematical methods of interpolation, for example).

In this case, the plurality can comprise a sufficient number of containers so that the generated relationship has a sufficient or desired significance and/or variance.

It is also conceivable that a functional relationship is determined or generated between a relative position of the closure viewed in the closing direction with respect to the container provided therewith and the closure rotational angle variable, which is described in the context of a (mathematical) function.

Such a relationship can be used, for example, to determine a highly precise closure rotational angle variable on the basis of a relative position of the closure depicted in at least one spatially resolved image (recorded by an image recording device) with respect to the container provided therewith.

The present invention is further directed to a method for operating a closure apparatus for closing containers with closures, wherein the containers are transported along a predefined transport path by a transport device.

According to the invention, the closure apparatus detects at least one of the sealing variable determined according to at least one (preferably a combination of several and preferably all) of the previously described method steps according to a preferred embodiment of an above-described method (for inspecting containers provided with closures), and carries out a control and/or regulation of the closure process as a function of this at least one sealing variable.

A disadvantage of the prior art is the lack of feedback of the closure rotation angle to the capper. No automated readjustment can take place.

Advantageously, a manual readjustment of the closure head by the control loop is superfluous in extensive parts.

The capper or the closure apparatus preferably has one or more units (preferably consists of one or more units). With system outputs>10,000 bottles/h, preferably several closure units, the so-called closure heads in this case, are required to apply closures to the mouthpiece continuously. The closure head receives the closure and with a rotational movement places it on the mouthpiece. The threads of the mouthpiece and of the closure engage one another and the closure is screwed on with a corresponding advancement. The process is terminated when a defined torque is reached. In this case, the necessary termination device can be a mechanical apparatus, a coupling which is disconnected when a specific value is reached or a torque characteristic of a motor, which stops after a specific number of revolutions, for example after the threading process, at a specific torque or a specific torque increase.

The closure head preferably has apparatuses in order to (first) receive the closure, (secondly) hold the closure securely during the threading and attachment process (in particular the screwing process) and/or (thirdly) stop the screwing process and/or (fourthly) release the closure at the end of the closure process. The apparatuses in particular need to be adapted for each closure head and for differently shaped closures.

The closure process, in particular the attachment process (movement of the closure onto the container), preferably the screwing process, can be performed by means of an (electric) motor or a servomotor. When a preset limit torque (or torque) is reached, the motor terminates the attachment process, in particular the screwing process. These types of cappers are known as servo-cappers.

The screwing process can be performed by means of a permanently driven (planetary) transmission on all closing elements; the termination of the screwing process is realized by a magnetic coupling by decoupling at a preset limit torque. It is a so-called hysteresis coupling or a variant modified therefrom.

In a preferred method, the closure apparatus has a plurality of closure units, wherein each closure unit, in particular independently of the other closure units, carries out a closure process on its own and can thereby apply a closure to a container.

The individual closure head can preferably be controlled individually.

Differences from closure head to closure head are advantageously eliminated.

In the case of screw closures, the control of the closure apparatus and/or of a (preferably each) closure unit is performed on the basis of a limit torque (to be applied by the pre-closure apparatus and/or the corresponding closure unit) as a nominal variable (for example, with a servo-capper and/or with the magnetic coupling).

Preferably, the control of the closure apparatus and/or of a (in particular each) closure unit is designed as a multi-variable controller, wherein the limit torque and a rotational speed can preferably be controlled.

The control is preferably operated based on a fuzzy logic.

The sealing variables determined according to any of the methods described above are associated with those closure units which have carried out the corresponding closure process, wherein a control and/or regulation of the closure process of the plurality of closure units is performed in each case depending on the at least one sealing variable associated with the corresponding closure unit. If the measured values are present in an organ-related manner (closure-unit-related), the controller can advantageously control the nominal variable for each organ (closure unit) individually.

In a further preferred method, a current state and a target state of the closure apparatus and/or of one of the plurality of closure units is detected, and a state variable that is characteristic of a failure probability and/or a maintenance requirement is determined depending on a comparison of the current state to the target state.

A disadvantage of the prior art is the lack of state detection and the associated prediction of the next maintenance.

The comparison with a target state makes predictions about reliability possible. A maintenance interval can thus be moved ahead or also reliably postponed in the future (predictive maintenance).

The comparison to a target state makes it possible to make statements about the nature of the closure head.

After an overhaul, repair or replacement of one or all closure units (closure heads), not all types have to be newly set. The labor-intensive effort is eliminated.

In this case, the target state can be a digital twin (in particular of the closure apparatus), empirical values (stored on a memory device), expert knowledge, a control, collected comparative values of the capper in an error-free state, comparative values collected from other cappers (closure apparatuses), or can be determined on the basis of these.

A difference from the target state is preferably detected and evaluated (by an, in particular, processor-based evaluation device) in order to determine the state variable. The difference is preferably compared to statistical limit values (in particular stored on a memory device). A temporal change (in particular in the current state and/or in a comparison value formed on the basis of the comparison) and/or in the change speed is preferably compared to limit values. This offers the advantage that, in the event of rapidly progressing (negative) changes, it is possible to react promptly.

A difference from the target state, a repeated reaching of limit values and/or (predefined) states (in particular historical) is preferably detected and evaluated (in particular with regard to the frequency of occurrence within a predefined time interval).

An overall state (and/or the state variable) is preferably determined on the basis of the historically detected course, and a prediction is preferably determined for future failure probabilities, repairs and the like on the basis of the historically detected course.

In a further preferred method, a control and/or regulation and/or maintenance of the closure apparatus takes place depending on an, in particular, trainable machine learning container closure model, which comprises in particular a set of trainable parameters which are set to values which have been learned as a result of a training process, wherein the training process is carried out on the basis of a set of training data.

Preferably, the training data comprise at least one attachment variable, in particular a screw-on depth, that is characteristic of a relative position of the closure which is present in relation to the closure direction relative to the container provided therewith, and a variable that is characteristic of the corresponding closure process (such as the attachment torque).

The machine learning container closure model is preferably based on an (artificial) neural network. The neural network is preferably designed as a deep neural network (DNN), in which the parameterizable processing chain has a plurality of processing layers, and/or a so called convolutional neural network (CNN) and/or a recurrent neural network (RNN).

Preferably, the (to-be-processed) data, in particular closure-specific and/or container-type-specific, and/or closure-unit-specific sealing variables (in particular an attachment variable and/or a distance variable and/or an insertion depth and/or a screw-on depth) (or data derived therefrom), which were preferably determined by the inspection apparatus and/or in the context of the method described above for inspecting containers provided with closures, are supplied as input variables to the container-closure model or the (artificial) neural network. The container-closure model or the artificial neural network preferably forms the input variables depending on a parameterizable processing chain to output variables.

Preferably, at least one nominal variable for controlling and/or regulating the closure process (of the closure apparatus), preferably a variable that is characteristic of an attachment torque (in particular a (limit) torque), is selected as an output variable.

Preferably, at least one nominal variable for controlling and/or regulating the closure process (of the closure unit), preferably a variable that is characteristic of an attachment moment (in particular torque), is selected as an output variable for each closure unit.

The machine learning container closure model is preferably trained using predefined training data, wherein the parameterizable processing chain is parameterized by the training.

In a preferred method, training data are used in the training process of the container closure model which comprise sealing values determined by the inspection apparatus and/or as part of the method for inspecting containers provided with closures (preferably attachment variables, insertion depths and/or screw-on depths or variables characteristic therefor), preferably specific to one or more closure units of the closure apparatus. It is also conceivable that training data are used on the basis of different (preferably structurally identical) sealing variables determined by closure and/or inspection apparatuses. This offers the advantage that a high amount of training data can be generated in a short time and any malfunctions of the inspection device and/or the closure device can be discovered.

Preferably, the determined sealing variables provided for use as training data are provided with (container and/or closure) type features (for example, color or composition of the closure) and/or classification features (for example, a predefined target sealing variable, which indicates whether the corresponding sealing variable, in particular depending on the container and/or closure types are sufficient for performing the sealing function).

Preferably, the determined sealing variables together with the container types and/or closure-types assigned thereto and/or features that are characteristic of a closure composition (color contribution, additives, in particular friction-influencing components), and/or classification features are stored and/or used as a training data set (in particular on a and/or the non-volatile memory device). A multitude of training data sets is preferably generated in this way.

By varying the attachment torques, in particular the torques on the capper or on the closure apparatus and the correlation with the screw-on heights, it is theoretically possible to determine a correlation between the height of the closure and/or between the above-determined sealing variable (and/or attachment variable and/or insertion depth and/or screw-on depth) and the screw-on values of the closure apparatus (of the closure unit), such as a servo-capper.

Due to the fact that ten and more closure heads or closure units (in the closure apparatus) are provided, a torque determination can preferably be carried out for each closure and bottle combination during production on the basis of the data. This advantageously replaces external quality control on a long term basis.

The cross-comparisons and the control of the heads can thus generate a stable closure image independently of any changing boundary conditions. Whether it be material or lubrication by water, etc.

A neural network (as a container closure model) trained in this way is preferably used. Training is preferably carried out by means of monitored learning. However, it would also be possible to train the container closure model or the artificial neural network by not monitored learning, reinforcement learning, or stochastic learning.

Additionally or alternatively, it is possible for the training data to comprise at least one variable that is characteristic of a current state of a closure apparatus.

Preferably, the data (to be processed), in particular a detected current state of the closure apparatus, preferably at least one detected current state of a closure unit and particularly preferably at least one detected current state per closure unit (or data characteristic thereof or derived therefrom), which were preferably determined by the closure apparatus, are supplied as input variables to the container closure model or the (artificial) neural network. The container-closure model or the artificial neural network preferably forms the input variables depending on a parameterizable processing chain to output variables.

Variables that are characteristic of a current state can be nominal variables and/or control variables that are required (in the context of a control).

Preferably, at least one state variable and/or a variable that is characteristic of maintenance and/or an error state of the closure apparatus is selected as the output variable.

Preferably, at least one state variable and/or a variable that is characteristic of maintenance and/or an error state and/or failure probability of the closure apparatus are selected as output variables for each closure unit.

The machine learning container closure model is preferably trained using predefined training data, wherein the parameterizable processing chain is parameterized by the training.

In a preferred method, training data are used in the training process of the container closure model, said training data comprising historically detected data, in particular for limit values and/or states, limit values for repeated reaching of limit values and/or states, limit values for a change in time and/or a speed change of values characterizing the current state, statistical limit values and/or states of closure and/or inspection apparatuses that are different from the closure apparatus (and/or inspection apparatus) (but preferably identical in construction). This offers the advantage that a high amount of training data can be generated in a short time and any malfunctions of the inspection apparatus and/or the closure apparatus can be discovered.

The training data preferably comprise as a classification feature the information as to whether the state corresponds to a (fault-free) control mode and/or whether there is a malfunction and/or whether an (advancing) aging state of the closure apparatus and/or the inspection apparatus is present.

The container-closure model is preferably suitable and intended to recognize (in the training data) deviations and/or anomalies and/or patterns which detect an error state and/or malfunctions and/or an (advanced) aging of elements of the closure apparatus and/or of the inspection apparatus and/or a maintenance requirement of the closure apparatus and/or of the inspection apparatus.

The container-closure model preferably outputs a probability value (as an output variable) characteristic of this, depending on the input variables.

Preferably, neural controller are used based on the measured values and data or parts of above-described target states by means of machine learning methods. These can be pre-trained, originate from simulations or from other, similar machines.

The states (or variables that are characteristic for this) are preferably retrievable and/or detectable by and/or via an external server, in particular a cloud.

The connection of the measurement values and data of different cappers to a cloud makes it possible to collect many states from different locations and to develop faster and or better neural controllers with the collected information.

Building on the AI and machine learning methods, a reliable predictive maintenance can be determined.

The collected states, measured values, and data make it possible to automatically recognize serial errors or weak points and to avoid them in the machine life cycle in a continuous improvement process in the future.

The present invention is further directed to an inspection apparatus for inspecting containers provided with closures for checking a sealing function between the closure and a container provided therewith. In this case, the closure is preferably arranged by arranging it (or by moving the closure onto the container) in the closure direction on a mouth region of the container.

The inspection apparatus has a transport device for transporting the containers provided with closures along a predefined transport path.

The inspection apparatus preferably has a lighting device for illuminating the containers provided with the closures, at least in regions, during this transport.

The inspection apparatus has at least one image recording device for recording at least one spatially resolved image of the container to be inspected that is provided with the closure (10a).

According to the invention, the inspection apparatus is suitable, specified and/or intended for checking the sealing function, such that the at least one spatially resolved image is recorded by the at least one image recording device in such a way that a relative position of the closure in the closure direction relative to the container provided therewith is thereby depicted, in particular a distance between the closure and the container, as seen in the closure direction.

According to the invention, the inspection apparatus has an image evaluation device, in particular processor-based, (in particular of the inspection device, wherein the image evaluation apparatus is preferably fixedly connected to the inspection apparatus) which, on the basis of the relative position depicted in the at least one spatially resolved image, determines at least one sealing variable characteristic of a performing of the sealing function.

It is therefore also proposed within the scope of the apparatus according to the invention that, instead of a determination of a relative rotational position of the closure relative to the container (marked for this purpose), a relative longitudinal position (along the closure direction and/or longitudinal direction of the container) is determined.

The inspection apparatus can thereby be configured to be suitable and/or intended to carry out the method steps or features described above in connection with the method for inspecting containers provided with closures, individually or in combination with one another. Conversely, the method described above, in particular the apparatus described in the context of the method for inspecting containers provided with closures, can have and/or use all features described in connection with the inspection device, individually or in combination with one another.

Preferably, the transport device is a transport belt, in particular a transport belt, on which the containers to be inspected are transported upright and on a single track. In this case, this transport belt particularly preferably has guide devices which guide the transport movement and/or the containers during their transport. These guide devices can in particular prevent lateral displacement of the container on the transport belt.

The image recording device is preferably selected from a group which comprises a camera (in particular detecting within the optically visible region), a CMOS Sensor (CMOS-abbreviation for “complementary metal oxide semiconductor”), a 3D sensor, an image recording device on X-ray basis, an optical element, a thermal imaging camera, and the like, as well as combinations of these.

Particularly preferably, the inspection apparatus has at least two, preferably at least three, and preferably at least four image recording devices. Preferably, these image recording devices are each aligned with the mouths and/or the closures of the containers. In addition, however, a recording would also be possible using mirrors, optionally with the same image recording device.

Particularly preferably, the image recording device is suitable and intended for increasing the contrast of a recorded image. In this case, for example, preprocessing of a recorded image is carried out in order to increase the contrasts thereof.

The present invention further directed to an inspection apparatus for inspecting containers provided with closures for checking a sealing function between the closure and a container provided therewith, wherein the closure is arranged by performing a screwing-on operation on a mouth region of the container and is thereby arranged in the closing direction on a mouth region of the container, with a transport device for transporting the containers provided with closures along a predetermined transport path, with a lighting device for illuminating the containers provided with the closures at least in regions during this transport, and with at least one image recording device for imaging at least one spatially resolved image of the container to be inspected which is provided with the closure.

According to the invention, the inspection apparatus is suitable, intended and/or configured for checking the sealing function, in such a way that the at least one spatially resolved image is recorded by the at least one image recording device that thereby, viewed in the closure direction, a relative position of the closure with respect to the container provided therewith is depicted, and an image evaluation device determines, on the basis of the relative position depicted in the at least one spatially resolved image, at least one closure rotation angle by which the closure was rotated in the course of the performed screwing-on operation, a characteristic closure rotation angle variable.

The inspection apparatus can thereby be configured to be suitable and/or intended to carry out the method steps or features described above in connection with the two methods for inspecting containers provided with closures, individually or in combination with one another. Conversely, the two methods described above, in particular the apparatus described in the context of the method for inspecting containers provided with closures, can have and/or use all features described in connection with the inspection apparatus, individually or in combination with one another.

The inspection apparatus can have all the features described above in connection with the above-described inspection device, individually or in combination with one another. Conversely, the above-described inspection apparatus can have and/or use all the features described in connection with the inspection apparatus described here individually or in combination with one another.

The invention is further oriented toward a closure apparatus for closing containers with closures, wherein the containers are transported along a predefined transport path by means of a transport device.

The image evaluation device is preferably located downstream of the closure apparatus.

According to the invention, the closure apparatus is suitable and intended to detect at least one of the methods described above for inspecting a sealing variable determined with closures of containers and to carry out a control and/or regulation of the closure process depending on this at least one sealing variable.

The closure apparatus can thereby be configured to be suitable and/or intended to carry out all method steps or features described above in connection with the method for operating a closure apparatus, individually or in combination with one another. Conversely, the method described above, in particular the apparatus described in the context of the method for operating a closure apparatus, can have and/or use all features described in connection with the inspection apparatus, individually or in combination with one another.

Preferably, the external server is a cloud-based external server, wherein the server is accessed (in particular by the closure apparatus) in particular via the Internet (and/or via a public and/or private network, in particular at least in portions wired and/or wireless, public and/or private). An external server is to be understood in particular to mean an external server, in particular a backend server, in relation to a closure apparatus.

The external server is, for example, a backend in particular of a closure apparatus and/or inspection apparatus manufacturer or of a service provider. The functions of the backend or the external server can be carried out in (external) server farms. The (external) server can be a distributed system.

The invention is further directed to a system for closing containers comprising an above-described closure apparatus (according to a preferred embodiment) and (arranged in particular downstream in the direction of the transport flow) an inspection apparatus described above (according to a preferred embodiment). The closure apparatus and the inspection apparatus preferably have a communication apparatus suitable for real-time data exchange between one another.

### BRIEF DESCRIPTION OF THE DRAWINGS

Further advantages and embodiments can be seen in the accompanying drawings:

In the drawings:

FIG. 1 shows a representation to illustrate the circumstances underlying the invention;

FIG. 2 shows a rough schematic representation of an apparatus for inspecting containers;

FIG. 3a shows a representation of an inspection apparatus according to the invention in a further embodiment;

FIG. 3b shows a schematic plan view of a preferred arrangement of four image recording devices in an inspection apparatus according to the invention in a further embodiment;

FIG. 3c shows a cross-sectional view of an inspection apparatus according to the invention in a further embodiment;

FIG. 4 shows a representation of a closure arranged on a mouth region of a container for illustrating the circumstances underlying the invention;

FIG. 5 shows a sectional view of a detail of a closure arranged on a mouth region of a container to illustrate the circumstances underlying the invention;

FIG. 6 shows a representation of a preform to illustrate the circumstances underlying the invention;

FIG. 7 shows a representation of an exemplary closure having features present thereon;

FIG. 8 shows a schematic representation of a control loop for controlling a closure apparatus according to the invention according to a preferred embodiment; and

FIGS. 9a, 9b show a histogram for representing an evaluation of organ-related data in reference to the mean value (FIG. 9a) and the standard deviation (FIG. 9b) of measurement values resulting from a height control of closures;

FIG. 10 shows a representation of known closures from the prior art;

FIG. 11 shows a schematic representation of an inspection apparatus according to the invention for containers provided with closures according to a preferred embodiment;

FIG. 12 shows four schematic representations of camera images;

FIG. 13 shows a schematic representation to illustrate a relationship between a relative position of the closure with respect to the container connected thereto and a closure rotation angle (independent of markings); and

FIG. 14 shows three schematic representations of a container 10 provided with a closure 15 for different closure rotation angles.

### DETAILED DESCRIPTION OF THE INVENTION

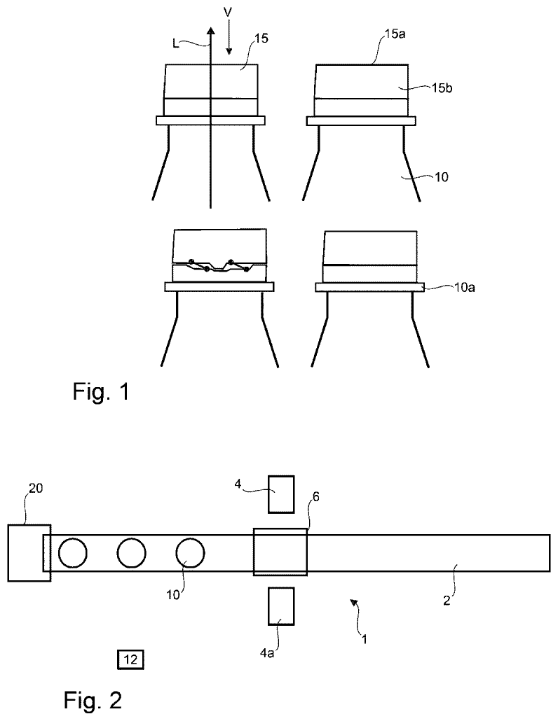

FIG. 1 shows four representations of a container, in this case a plastics material container 10 having a (container) closure 15. This (container) closure 15 is preferably screwed onto an opening, in particular a mouthpiece, of the container 10.

The reference numeral L refers to a longitudinal direction of the container and also to a longitudinal direction of the container closure 15.

The reference sign V designates an arrow indicating the closure direction. In this closure direction, the closure is moved when the closure 15 is attached to the container 10 or when the closure 15 is moved onto the container (during the closure process). In the case of screw closures, the closure is rotated simultaneously with this linear movement about the closure direction in order to screw it onto a thread developed on the mouth region (or the mouth) of the container.

Here, the closure direction extends along the longitudinal direction L (with an oppositely occupied direction). Preferably, the closure direction V and/or the longitudinal direction runs along a central axis of the container (through the main body and/or the bottom region). Preferably, the closure direction V and/or the longitudinal direction runs along a central axis of an opening of the container to be closed with the closure and/or along a central axis of a mouth region of the container 10 to be closed with the closure 15.

The container closure has a cap portion 15a and a circumferential wall 15b. A texture (not shown) may be formed on the circumferential wall 15b.

Reference numeral 10 a refers to a support ring arranged on the container 10. This is preferably likewise recorded.

FIG. 2 shows a rough schematic representation of an apparatus 1 according to the invention for inspecting containers 10 according to a preferred embodiment. This apparatus has a transport device such as a transport belt 2, which transports the containers 10 along a predetermined transport path, in this case a straight transport path.

The reference signs 4 and 4a refer to image recording devices (in this case, two, arranged preferably about 180° in relation to one another) which respectively record images of the filled and closed containers 10. Advantageously, four such image recording devices 4, 4a (arranged approximately 90° in relation to one another) are provided (of which only two are shown in FIG. 2), which particularly preferably each record altogether four images of the containers from different directions.

The reference numerals 6 refer to illumination devices which are preferably associated with the image recording devices and which illuminate the containers 10 at least during image recording.

The reference sign 12 schematically indicates an image evaluation device which evaluates the images recorded by the image recording device(s) and in doing so preferably also determines the sealing variables described above.

The reference sign 20 designates a closure apparatus arranged upstream of the transport direction on the transport device 2 for closing the containers 10 with closures.

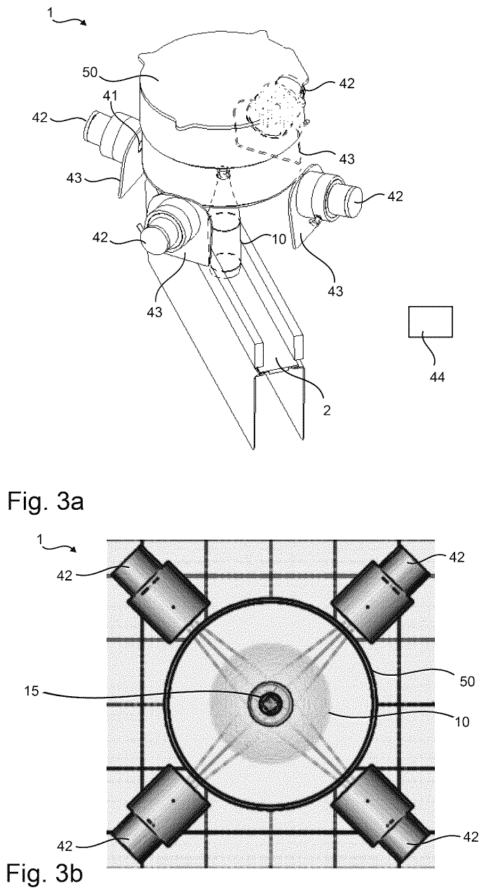

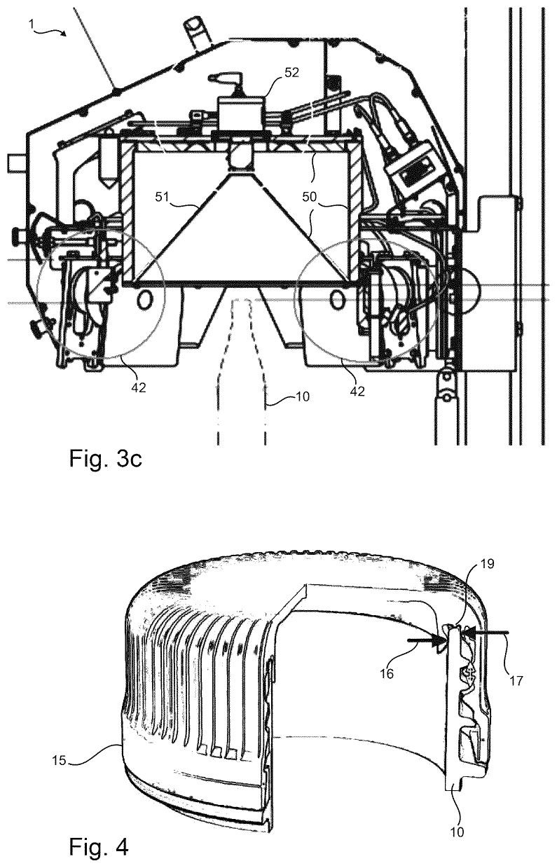

FIG. 3a shows an inspection apparatus 1 for inspecting containers 10 provided with closures according to a preferred embodiment. The reference sign 2 thus designates a transport device which guides the containers 10 to be inspected along a (predefined) transport path to the inspection apparatus 1, through said inspection apparatus and carries them away from it.

The inspection apparatus can thereby have one or more image recording devices 42, such as cameras. For example—as shown in FIG. 3a—it was possible to arrange four image recording devices.

The thin (preferably white) plates 43 around the (small) lens hole 41 shown here in FIG. 3a are the corresponding background for the opposite image recording apparatus 42, which is designed here as a camera (and diffuse scattering element 43). The camera angle of 15°-30° was chosen so that the opposite camera does not see the black hole 41 in the immediate environment of the closure cap 15a.

The steeper the camera looks downward, the higher in the camera image the black hole 41 of the opposite aperture is imaged in the own camera image. It is advantageous that the closure 15, including the closure cap, is bordered in the background by the white plate 43 and not partially with the black hole.

The image recording devices 42 can be arranged in such a way that several or all of these image recording devices 42 each record at least one image of the container 10 to be inspected while it is located substantially in at least one inspection position or while it is located in a (fixed) predefined inspection region. The container to be inspected is preferably in (transport) movement during the recording of the image by the image recording device(s) 42. Preferably, the transport speed of the container 10 to be inspected is not reduced, or not substantially reduced, for image recording, and in particular the container is not stopped for this purpose.

Furthermore, the inspection apparatus 1 has an image evaluation device 44, which is particularly processor-based.

The inspection apparatus 1 can furthermore have at least one (or several) lighting device(s) 50 for illuminating the container to be inspected. Preferably, exactly one lighting device 50 is provided which is arranged (perpendicularly) above the container and above the transport device 2. The main lighting direction of the lighting device is preferably perpendicular to the transport direction and particularly preferably parallel to the longitudinal direction of the container (which is preferably transported upright and/or on a single track on the transport device 2).

FIG. 3b shows a schematic plan view of a preferred arrangement of four image recording devices 42, in this case designed as cameras, of an inspection apparatus 1 which are arranged at a 90° angle to one another and in each case inspect one, in particular the same, container 10 (to be inspected). The reference sign 50 designates a lighting device and/or lighting screen which is circular in plan view and is arranged above the image recording devices 42.

FIG. 3c is a cross-sectional view of an inspection apparatus according to the invention in a further embodiment. The reference sign 10 in turn designates a container which is provided with a closure. The circles designated with the reference sign 42 indicate the position of the image recording devices (cameras) (two lateral cameras of four preferred cameras can be seen), each of which records an image of a container and/or closure region.

For inspection, the container 10 (and its closure) is illuminated by a lighting device 50, preferably via a diffuse incident light illumination. The illumination location is preferably above the closure of the container. Preferably, the lighting device 50 has a preferably (truncated) cone-shaped diffusing screen 51. The cone-shaped diffusing screen 51 is shown in FIG. 3c in a cross-sectional view. The lighting device 50 preferably has an outer shell which is designed in the form of a cylinder in a preferred embodiment shown in FIG. 3c. The (truncated) cone 51 of the lighting device 50 is preferably inverted inward and/or open downwards, i.e. without a final protective screen.

The illumination diameter is preferably selected to be >150 mm, preferably >220 mm, particularly preferably >280 mm.

Preferably, the following applies for the lighting direction: diffusely from above, so that the closure and the container geometry (support ring, shoulder, . . . ) is uniformly illuminated. Light from above produces shiny points on the elevations, shadows at the depressions; light from further outside produces the uniform basic lighting.

The lamp surface (of the lighting device) is particularly preferably a conical lighting screen 51. A further camera (or image recording device) 52 is preferably arranged in the center of the cone, which further camera checks the closure cap 15a, for example, for a correct label (for example, a label of the beverage manufacturer). In other words, in a preferred embodiment, a camera 52 arranged in the center of the cone 51 looks through a hole in the (truncated) cone 51 onto the closure cap 15a and inspects it. However, it is also conceivable that the inspection apparatus does not have a camera in the center of the cone.

The lighting screen can preferably be a flat pane (for example, if the further camera is not taken into account).

FIG. 4 shows a representation of a closure arranged on a mouth region of a container to illustrate the circumstances underlying the invention.

FIG. 4 shows a closure 15 which has been developed in particular for products to be filled with a high carbonic acid content and which tightly seals off the mouth region of the container and can be safely opened. The closure 15 shown here has two (three) seals, which are designated by the reference signs 16 and 17 (19); one on the inner side and one on the outer side, in order to prevent minor damage on the neck.

The markings known from the prior art and provided for determining a rotational position on the closure and/or support ring are in the actual sense reference markings in order to be able ultimately to measure the distance between the closure and the front face of the mouthpiece. The sealing function between the closure and the mouthpiece is ensured if the closure is immersed with its sealing lips on the upper end of the mouthpiece, which is illustrated by the arrows marked with the reference signs 16 and 17.

The indirect measured variable of the closure rotation angle for the distance between the closure and the front face of the mouthpiece is preferably replaced by a true distance measurement between the rigid mouthpiece parts and the closure.

The aim of the angle is to determine the screw-on depth. The angular position is repeated when screwing on with every rotation. Typically, a one-piece thread has a slope of approximately 1.5-3.5 mm, depending on the design. A slope of 1.8 mm is assumed by way of example. That is, one revolution changes the closure distance by 1.8 mm. If the sealing function is present within a distance tolerance of 0.3 mm between the mouthpiece and the closure, a permissible angular tolerance can be converted. In the example, it is 0.3 mm/1.8 mm×360°=60°. However, the angle is just a reference variable indirectly via the thread pitch. The variable to be determined is whether the sealing function in the closure is situated sufficiently deeply on the mouthpiece.

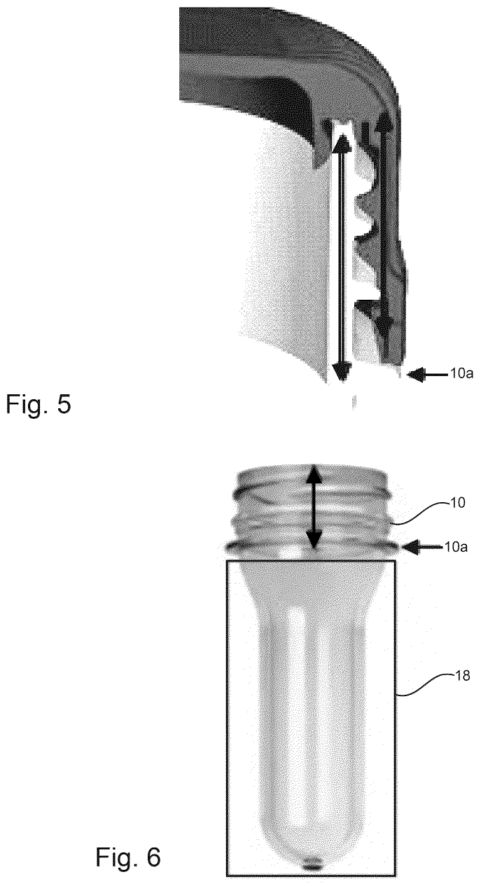

FIG. 5 is a sectional view of a closure 15 arranged at a mouth region of a container 10 to illustrate the circumstances underlying the invention.

In this example shown in FIG. 5 of a closure arranged on the mouth area, an embodiment can already be seen in which the support ring 10a does not protrude beyond the closure. A marking on the support ring can no longer be metrologically detected from above or laterally at the same time with a marking applied on the closure.

FIG. 6 shows a representation of a preform from which a ready-blown container to be filled (and subsequently to be closed) is produced by a blow molding process, to illustrate the circumstances underlying the invention.

The mouthpiece is designed to be rigid up to the support ring. Below the support ring, the part to be stretched begins. This partial region of the preform, which is illustrated here by a rectangle denoted by the reference sign 18, is shaped into the container shape during the production of a PET container.

It is therefore preferably proposed to determine the support ring 10a, the support ring underside, the support ring outer edge, the bend between the support ring and the stretchable or stretched region in its position.

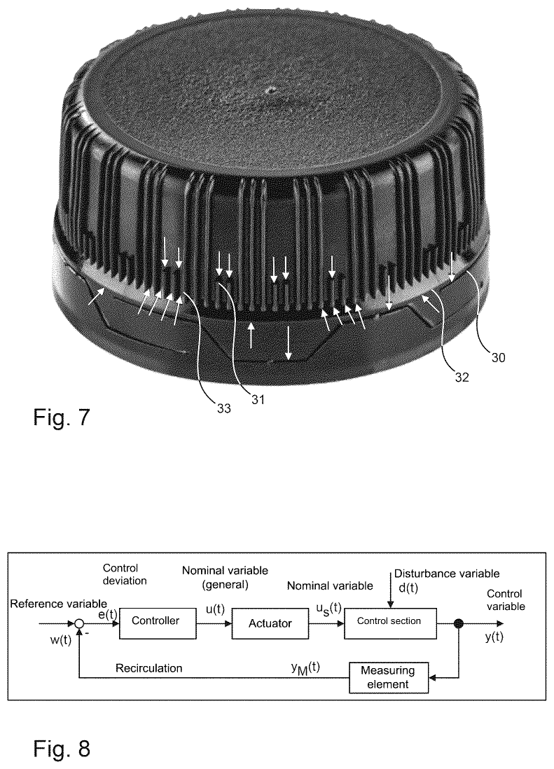

FIG. 7 shows an illustration of an exemplary closure 15 with (outer) features present thereon, by means of which the proposed method can preferably be carried out according to a preferred embodiment.

It is preferably proposed to determine the positions by external features on the closure 15 and also on the mouthpiece of the container remote from the special markings of the closure rotation angle.

It is particularly preferred to use the closure, the circumferential surface of the closure, particularly preferably features on the closure, and particularly preferably features arranged on the circumferential surface, in particular laterally on the closure, for position determination.

Features can be, for example, the knurled textures, projections 31, the perforation region 30 as a boundary to the locking ring, bends 32, grooves 33, and the like. The small arrows in FIG. 7 illustrate possible features.

The features for the rigid region are preferably fixedly connected to a sufficient extent.

FIG. 8 shows a schematic representation of a control loop for controlling a closure apparatus according to the invention according to a preferred embodiment.

An embodiment of the closure apparatus preferably has a (configured) control loop (for controlling at least one variable that is characteristic of the closure process).

The control loop can be designed as a classic PID controller, with the three parts, the P=proportional, the I=integral, and D=differential portion. Sub-embodiments thereof are the combinations of one or two components thereof. The best-known are P controllers, PI controllers, and PD controllers.

The control loop can control, for example, the limit torque in the servo-capper as a nominal variable.

The control loop can control, for example, the limit torque of the magnetic coupling as a nominal variable.

The control loop can control, for example, the limit torque and the rotational speed as a multi-variable controller.

If the measured variables are organ-related, the controller can individually control the nominal variable for each organ.

The control loop can be operated with the principle of fuzzy logic.

Preferably, the control loop is compared to a target state. The target state can be a digital twin, the empirical values, the expert knowledge, a control, the collected comparative values of the capper for an error-free state and/or the comparative values collected at other cappers or closure apparatuses.

The difference relative to the target state is preferably detected and evaluated.

The difference is preferably compared to static limit values.

The change in time, the change speed is preferably compared to limit values.

The difference relative to the target state, the repeated reaching of limit values/states, is preferably historically detected and evaluated.

An overall state is preferably determined from the historically detected profile, and a prediction for future failure probabilities, repairs and the like is estimated.

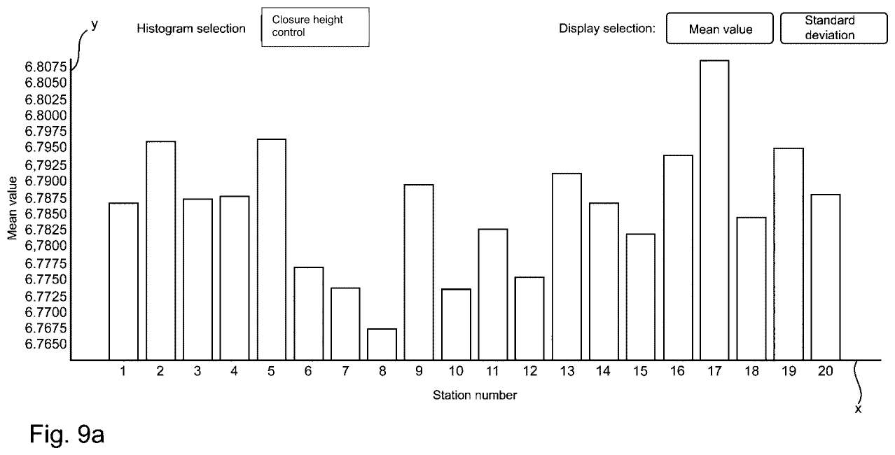

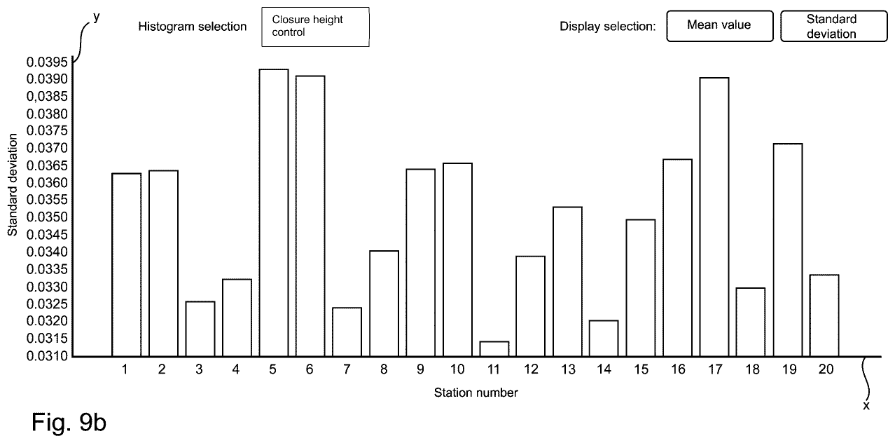

FIG. 9 shows a histogram for representing an evaluation of organ-related data in relation to the mean value (FIG. 9a) and the standard deviation (FIG. 9b) of measured values resulting from a height control of closures. The corresponding station number (of the closure unit) is plotted along the axis marked with the reference sign x and the mean value of the measured values (FIG. 9a) resulting from the height control and assigned to the respective station is plotted along the vertical axis marked y, and in FIG. 9b is the standard deviation assigned to the respective station of the measured values resulting from the height control and assigned to the respective station.

The measurement variables that are fed back (from the inspection apparatus to the closure apparatus), such as the measured values resulting from the height control and/or such as the (corresponding) sealing variables, and/or differences and/or states determined by the inspection apparatus, henceforth designated as data, can be collected as a sum relative to all closure heads. They can also be prepared individually for each individual closure head or closure unit (=an organ) (organ assignment).

It is therefore preferably proposed to organize the data as a whole, as well as organ-related. The data for n closure heads can be present individually, for example, and the totality can be determined from the organ-related values.

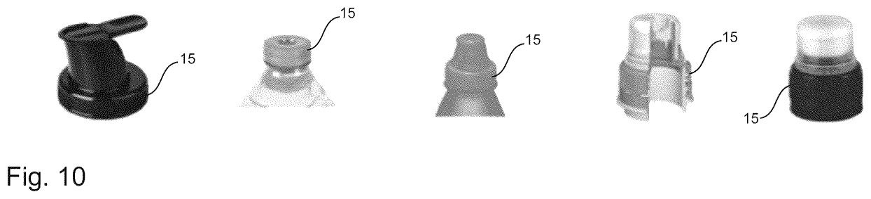

FIG. 10 shows a representation from closures 15 known form the prior art, by which, for example, the method proposed according to the invention for inspecting the closures arranged on containers can be carried out. In particular, multipart threads can be reliably processed. The ambiguity of the closing angle is eliminated.

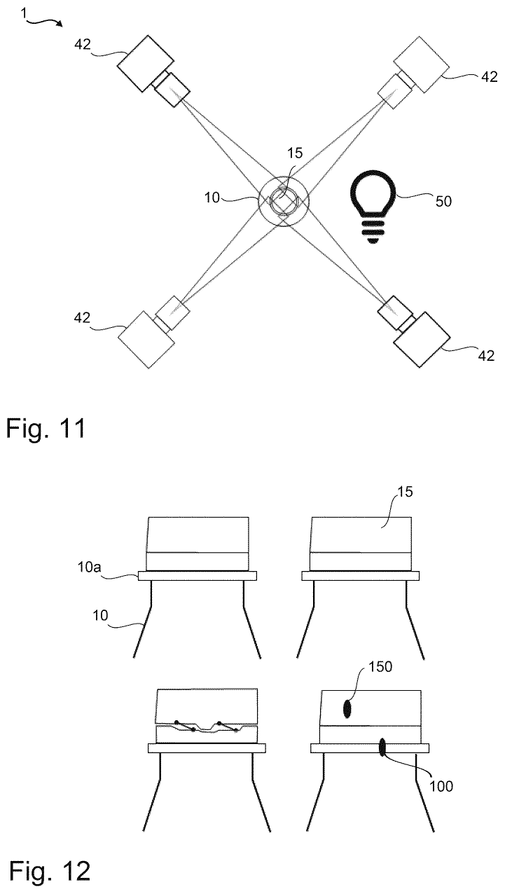

FIG. 11 shows a schematic (top view) representation of an inspection apparatus according to the invention for containers 10 provided with closures 15 according to a preferred embodiment, which is preferably suitable and intended for the precise detection of a closure rotation angle in two stages.

Preferably (here as well), is a lighting device 50 for illuminating the container 10 (arranged in particular at a predetermined inspection position) and/or the closure 15 arranged thereon. In particular, the closure 15 and preferably a support ring and/or a shoulder region of the container 10 are illuminated (in particular diffusely).

The inspection apparatus has preferably two or—as shown here-four image recording devices 42 which are preferably arranged at an angle of 90° to each other around the inspection position or the container 10 provided with the closure 15. The image recording devices 42 each record at least one image in which preferably in each case a region of the closure 15 and a region of the container 10 (for example the support ring of the container) is depicted.

A relative position (viewed in the longitudinal direction L of the container 10) is preferably depicted between the closure 15 and the container 10 so that a relative (screw-on) height of the closure with respect to the container 10 (for example relative to its support ring) can be derived from the recorded image data.

FIG. 12 shows four schematic representations of camera images. In this case, the reference sign 10 in turn identifies the container which is provided with the closure 15. The sealing of the closure 15 (closure cap) with respect to the container 10 is to be checked.

The reference sign 150 indicates a marking arranged on the closure. Using this marking 150, it is possible to clearly identify a rotational position of the (otherwise preferably at least discrete, preferably continuously rotationally symmetrical) closure 15.

The reference sign 100 indicates a marking arranged on the support ring 10a. Using this marking 100, it is possible to clearly identify a rotational position of the (otherwise preferably at least discrete, preferably continuously rotationally symmetrical) support ring 10a and/or container 10.

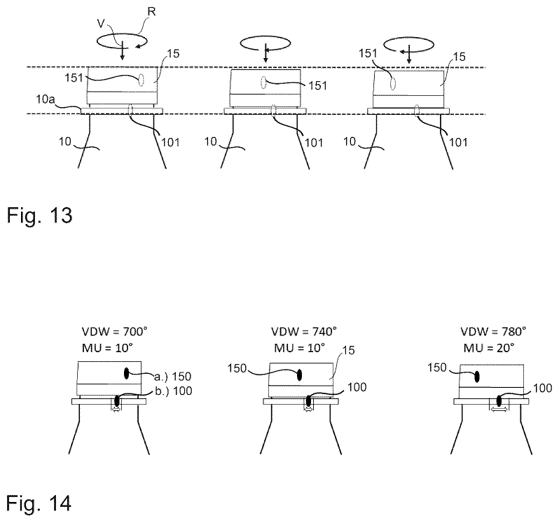

FIG. 13 shows a schematic representation to illustrate a relationship between a relative position of the closure 15 with respect to the container 10 connected thereto and a closure rotation angle (independent of markings).

During a screwing-on process of the closure 15 onto a container mouthpiece (and an associated change in the screw-on height or a relative position of the closure with respect to the container connected thereto), the closure rotation angle changes in the process.

The change in the closure rotation angle during the screwing-on process is shown in FIG. 13 by an imaginary reference point on the closure 151 and by an imaginary reference point 101 on the support ring 10a of the container 10.

The three representations in this case each illustrate a screw-on state of the closure 15 on the container 10. In the illustrations shown here, the container 10 remains in a rotationally fixed position, while the closure 15 is rotated in the direction of rotation R illustrating the rotational movement, and is moved (linearly) towards the container along the closing direction V and thereby screwed on. If the closure is screwed far enough onto the container, the container is closed (tight).

The representation on the left shows a first rotational state in which the closure is arranged on the mouthpiece of the container and can be located, for example, at a threading position of an external thread of the mouthpiece. The imaginary reference point 151 can be seen in FIG. 13 in a region on the right.

The middle representation shows a further rotational state which results from the first rotational state after a (further) screwing-on process. It can be seen with reference to the imaginary reference point 151 on the closure 15 that the rotational position of the closure 15 has changed by the screwing-on process. It can also be seen that the distance (viewed in the closing direction V) between the closure 15 and the support ring 10a has decreased, or the relative position (viewed in the closing direction V) of the closure 15 has changed with respect to the support ring 10a.

The representation on the right shows a further rotational state, which is, for example, a rotational state in which the container 10 is tightly closed. Again, the position of the imaginary reference point of the closure has changed with respect to the further rotational state shown in the middle representation as a result of the further screwing-on process, and is now located in a left region of the illustration on the right. Due to the screwing-on movement, the closure is now in contact with the support ring; the distance (viewed in the closing direction V) is zero here. The relative position of the closure (viewed in the closing direction V) has thus changed again with respect to the container, in particular with respect to the support ring of the container. The closure rotation angle can be determined via the relative position using the known thread pitch.

FIG. 14 shows three schematic representations of a container 10 provided with a closure 15 for different closure rotation angles (VDW) from step 1 (with known measurement accuracy). The closure rotation angle (VDW) in this case is determined with respect to a threading (rotational) position. “MU” denotes a measurement inaccuracy.

The three representations show a closure 15 provided with a marking 150, and arranged on the container with a support ring provided with a marking 100 in different closure rotational angles, namely VDW=700° (left illustration), VDW=740° (middle illustration) and VDW=780° (right illustration).

The three representations illustrate that the measurement inaccuracy MU for the first two closure rotation angles 700° and 740° is relatively small and is 10°, whereas the measurement inaccuracy with a closure rotation angle VDW=780° has already doubled to MU=20°.

That the measurement inaccuracy changes can, for example, be related to the fact that the closure rotation angle no longer changes in the same way as the screw-on height, for example, during a final screwing-on phase of the screw-on process. Thus, for example, in an initial screwing-on phase of the screwing-on process, a linear relationship between the closure rotation angle and a relative position (viewed in the closing direction V) can exist between the closure and the container, which is predetermined by the thread pitch of the thread.

In the final screwing-on phase (in the last phase before an intended closure rotation angle is achieved), for example, there can be a relationship between the closure rotation angle and a relative position (viewed in the closing direction V) between the closure and the container different from an initial screwing-on phase.

The reason for a change of such a relationship can be explained with reference to the closure 15 shown in FIG. 4. In addition to the two sealing lips 16 and 17, this closure also has a seal 19 which is provided to seal the container 10 on the front face of the mouthpiece.

If the screwing-on process of the closure has progressed far enough with respect to the mouthpiece of the container 10, the seal 19 enters into contact with the front face of the mouthpiece. As soon as the seal 19 contacts the front face of the mouthpiece of the container 10, the screwing-on behavior of the closure can change in that, for example, the lateral surface of the closure is deformed (e.g. plastically and/or elastically) during the further progression of the screwing-on process. The changed screwing-on behavior of the closure 15 (compared to an initial screwing-on behavior of the closure) results in particular in a comparatively lesser change in the screw-on depth when a screwing-on process is carried out at the same rotational angle. This can also result in particular in greater measurement inaccuracy (MU) in this final phase of the screwing-on process.

If the closure angle has been determined (for example via the relative position) in a first step with a known measuring accuracy/spread (even if no marking has yet been searched for), the following method can be used in a second step if additional features are applied on the closure and container:
a. a first, suitable feature (this can very preferably be the feature of the closure—but theoretically also the feature of the container) is searched in the image.
b. starting from the first feature, the second feature is sought in a restricted region. ( . . . on the container or in the theoretical case, then on the closure)
c. the limited search region is greater than or equal to the measuring accuracy (plus the marking width)
d. the measurement accuracy is increased!
e. the robustness is increased with respect to one or more pseudomarkings on the container!

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 inspection apparatus
2 transport device
4, 4a image recording device
6 lighting device
10 container
10a support ring
12 image evaluation device
15 closure
15a cap portion
15b circumferential wall
15c locking ring
16, 17, 19 seals
18 partial region to be formed of the preform
20 closure apparatus
30 perforation region
31 projections
32 bends
33 grooves
44 image evaluation apparatus
50 lighting device
51 conical light screen
52 optional camera from above
L Longitudinal direction
V closure direction
X axis for applying the station number
y mean value/standard deviation of the measured values associated with the respective station

1. A method for inspecting containers provided with closures for checking a sealing function between the closure and a container provided therewith, wherein the closure is arranged by performing a screwing-on operation on a mouth region of the container and thereby arranging it in a closing direction on a mouth region of the container, wherein the containers are transported along a predefined transport path by a transport device, and during this transport the containers provided with the closures are illuminated by a lighting device, at least in regions, and at least one image recording device records at least one spatially resolved image of the container to be inspected that is provided with the closure,
wherein to check the sealing function, the at least one spatially resolved image is recorded by the at least one image recording device in such a way that, viewed in the closure direction, a relative position of the closure with respect to the container provided therewith is depicted, and an image evaluation device determines, on the basis of the relative position depicted in the at least one spatially resolved image for checking the sealing function, at least one closure rotation angle variable characteristic of a closure rotation angle by which the closure was rotated in the context of the performed screwing-on operation.

2. The method according to claim 1,
wherein
at least one expected variable characteristic of an expected region on the container and/or on the closure is determined depending on the determined closure rotation angle variable, in which a marking element is arranged on the container and/or the closure that is configured for an identification of a rotational position of the container and/or closure.

3. The method according to claim 2,
wherein
at least one evaluation region is selected from at least one spatially resolved image recorded by an image evaluation device depending on the at least one expected variable characteristic of an expected region on the container and/or on the closure, and wherein exclusively the image data of the evaluation region is evaluated to determine a marking element.

4. The method according to claim 2,
wherein
the expected region and/or the at least one expected variable is determined depending on a predefined and/or predefinable measurement inaccuracy of the closure rotational angle variable.

5. The method according to claim 2,
wherein
the expected region is a region which extends over a predetermined circumferential angle with respect to the longitudinal axis and/or to the closing direction.

6. The method according to claim 5,
wherein
the circumferential angle is less than 90°.

7. The method according to claim 1,
wherein
the closure and the container each have at least one marking element configured for identifying a rotational position of the container and/or closure, and these two marking elements are used to check the closure rotational angle variable and/or sealing variable determined on the basis of the relative position depicted in the at least one spatially resolved image.

8. The method according to claim 1,
wherein
the closure and the container each have at least one marking element configured for identifying a rotational position of the container and/or closure, wherein the position of one of the two marking elements is determined, and a rotational position of the other marking element is determined on the basis of the determined position of one of the two marking elements and on the basis of the characteristic closure rotational variable.

9. The method according to claim 8,
wherein
the position of the marking element on the closure is determined and, on the basis thereof, a relative rotational position of the marking element on the container with respect to the marking element on the closure is determined on the basis of the determined characteristic closure rotational variable.

10. The method according to claim 7,
wherein
the position of the marking element on the container is determined and, on the basis thereof, a relative rotational position of the marking element on the closure with respect to the marking element on the container is determined on the basis of the determined characteristic closure rotational variable.

11. The method according to claim 9,
wherein
at least one sealing variable characteristic of a fulfillment of the sealing function is determined from the determined relative rotational position of the marking element on the closure with respect to the marking element on the container.

12. The method according to claim 11,
wherein
a first sealing variable characteristic of a fulfillment of the sealing function and/or the closure rotation angle variable is determined without using a position of marking elements, and on the basis of the first sealing variable
and/or closure rotation angle variable, a fine determination of a sealing variable and/or a fine determination of a relative rotational position of the closure with respect to the container is made using a position of marking elements on the closure and the container.

13. The method according to claim 1,
wherein
the at least one image recording device records the containers from a direction which forms an angle of at most 60° with a horizontal plane perpendicular to the longitudinal direction of the container and/or with a horizontal plane perpendicular to the closure direction.

14. The method according to claim 13,
wherein
for a plurality of containers provided with closures, wherein the closure and the container each have at least one marking element, at least one spatially resolved image is recorded in such a way that a relative position of the closure with respect to the container provided therewith, viewed in the closing direction, is thereby depicted, and in each case at least one closing rotation angle variable is determined, and wherein on the basis of the plurality of at least one spatially resolved images or variables derived therefrom and on the basis of the determined closure rotation angle variables, a relationship is generated and/or determined between a relative position of the closure viewed in the closure direction with respect to the container provided therewith and the closure rotation angle variable.

15. A method for operating a closure apparatus for closing containers with closures, wherein the containers are transported along a predefined transport path by a transport device,
wherein
the closure apparatus detects at least one sealing variable which will be and/or is determined depending on the closure rotation angle variable determined according to claim 1, and a control and/or regulation of the closing process is carried out depending on this at least one sealing variable.

16. The method according to claim 15,
wherein
the closure apparatus has a plurality of closure units, wherein each closure unit is able to independently carry out a closure process and herein apply a closure to a container, wherein the determined sealing variables are associated with those closure units which have carried out the corresponding closure process, wherein a control and/or regulation of the closure process of the plurality of closure units takes place in each case depending on the at least one sealing variable associated with the corresponding closure unit.

17. The method according to claim 15,
wherein
a current state and a target state of the closure apparatus and/or one of the plurality of closure units is detected, and a target variable that is characteristic of a failure probability and/or a maintenance requirement is determined depending on a comparison of the current state to the target state.

18. The method according to claim 15,
wherein
a control and/or regulation and/or maintenance of the closure apparatus is performed depending on a machine learning container closure model, which comprises a set of parameters which are set to values which have been learned as a result of a training process, wherein the training process is carried out on the basis of a set of training data, wherein the training data comprises at least one attachment variable that is characteristic of a relative position of the closure relative to the container provided therewith in relation to the closure direction, as well as an attachment variable that is characteristic of the corresponding closure process.

19. An inspection apparatus for inspecting containers provided with closures for checking a sealing function between the closure and a container provided therewith, wherein the closure is arranged by performing a screwing-on operation on a mouth region of the container and is thereby arranged in the closing direction on a mouth region of the container, with a transport device for transporting the containers provided with closures along a predetermined transport path, with a lighting device for illuminating the containers provided with the closures at least in regions during this transport, and with at least one image recording device for imaging at least one spatially resolved image of the container to be inspected which is provided with the closure,
wherein
the inspection apparatus is configured for checking the sealing function, in such a way that the at least one spatially resolved image is recorded by the at least one image recording device in such a way that, viewed in the closure direction, a relative position of the closure with respect to the container provided therewith is depicted, and an image evaluation device determines, on the basis of the relative position depicted in the at least one spatially resolved image, at least one closure rotation angle by which the closure was rotated in the course of the performed screwing-on operation, a characteristic closure rotation angle variable.

20. A closure apparatus for closing containers with closures, wherein the containers are transported along a predefined transport path by a transport device,
wherein
the closure apparatus detects at least one sealing variable which will be and/or is determined according to claim 1, and, depending on this at least one sealing variable, carries out a control and/or a regulation of the closing process.
